(19) United States
(12) Patent Application Publication
(10) Pub. No.: US 2008/0002774 A1
(43) Pub. Date: Jan. 3, 2008

(54) Motion vector search method and motion vector search apparatus

(76) Inventors: Ryuya Hoshino, Osaka (JP); Koji Nakajima, Kyoto (JP)

Correspondence Address: MCDERMOTT WILL & EMERY LLP, 600 13TH STREET, NW, WASHINGTON, DC, 20005-3096, US

(21) Appl. No.: 11/819,370

(22) Filed: Jun. 27, 2007

(30) Foreign Application Priority Data
Jun. 29, 2006 (JP) 2006-179405

(51) Int. Cl. H04N 7/26

(52) U.S. Cl. 375/240.16; 375/E07.124

(57) ABSTRACT

A first motion vector is searched for based on a block retrieved from a first reference frame, while a second motion vector is searched for based on a block retrieved from a second reference frame. A combination of a block in the first reference frame and a block in the second reference frame is determined so that the correlation of an averaged block of a block retrieved from the first reference frame and a block retrieved from the second reference frame with the object block is the highest, to search for a motion vector pair based on the determined combination. A motion vector or motion vector pair highest in similarity is selected among the first and second motion vectors and the motion vector pair.

### CROSS-REFERENCE TO RELATED APPLICATIONS

This application claims priority under 35 U.S.C. §119 on Patent Application No. 2006-179405 filed in Japan on Jun. 29, 2006, the entire contents of which are hereby incorporated by reference.

### BACKGROUND OF THE INVENTION

1. Field of the Invention

The present invention relates to a motion vector search method used for compression of digital moving image data and a motion vector search apparatus for performing such motion vector search.

2. Description of Prior Art

In recent years, digital moving image compression technology has been applied to various fields such as digital broadcasting and optical disc videos such as DVDs (digital versatile discs) and the like.

One of compression methods for moving image data utilizes the correlation between two screens (frames) constituting part of a moving image. A typical technology for implementing such a compression method is motion compensated predictive coding, which is adopted in MPEG (Moving Picture Exports Group) that is an ISO/IEC-recommended moving image compression technology.

In the motion compensated predictive coding technology, a block most similar to an object block to be coded is searched for in a reference image, and a difference block between the object block and the most similar block, as well as a vector from the coordinates representing the position of the object block in the reference image to the most similar block, are coded, to thereby compress the information amount.

In MPEG, a moving image is composed of three kinds of pictures different in referring way: I pictures (intra coded images), P pictures (interframe forward predictive coded images) and B pictures (bidirectionally predictive coded images). Each picture is composed of a plurality of blocks (macro blocks).

A plurality of B pictures are normally inserted between I pictures or P pictures. B pictures can be subjected to motion compensated predictive coding by any of the following schemes: a forward reference scheme in which a temporally past picture is used as a reference image (called a forward reference image) to perform motion compensated predictive coding, a backward reference scheme in which a temporally future picture is used as a reference image (called a backward reference image) to perform motion compensated predictive coding, and a bidirectional reference scheme in which both a forward reference image and a backward reference image are used as reference images to determine an averaged block to thereby perform motion compensated predictive coding. By use of B pictures, in MPEG, the prediction precision in the motion compensated predictive coding improves, and thus efficient coding can be attained.

An example of conventionally known methods of motion compensated predictive coding is a coding algorithm for B pictures in MPEG-2 test model 5 (hereinafter, called TM5). In coding in TM5, first, a forward reference image is searched to detect a block most similar to the object block to be coded, and the motion vector representing motion from the object block to the detected block and the similarity (i.e., degree of correlation) therebetween are determined (forward motion vector search). A backward reference image is then searched to detect a block most similar to the object block, and the motion vector representing motion from the object block to the detected block and the similarity therebetween are determined (backward motion vector search). The obtained similar blocks are then averaged to obtain an averaged block, and the motion vector representing motion from the object block to the averaged block and the similarity therebetween are determined. Thereafter, the similarity in the forward reference, the similarity in the backward reference and the similarity in the bidirectional reference are compared with one another, to select the reference scheme having the highest similarity. As described above, in TM5, the motion compensated predictive coding can be implemented with a comparatively small computation amount.

Another method of motion compensated predictive coding adopts an algorithm for determining a motion vector without calculation of an averaged block itself, to attempt to reduce the circuit scale of a computation circuit for searching for a motion vector and also improve the processing speed (see Japanese Laid-Open Patent Publication No. 8-322049 (Patent Literature 1), for example). In this method, first, each pixel data in a similar block obtained in one of reference images is multiplied by ½, and the multiplied result is subtracted from corresponding pixel data in an object block to be coded, to generate a template block. Each pixel data in each block included in a search window of the other reference image is then multiplied by ½ to generate each candidate block. The difference between the template block and each candidate block is calculated for each corresponding pixel data and converted to positive-number data. Such positive-number data is summed up for each block, to thereby determine a distortion between an averaged block and the similar block. The motion vector is then determined for a candidate block giving the smallest distortion.

However, even though similar blocks are averaged as in TM5, the averaged block is not necessarily most similar to the object block to be coded.

Also, the method described in Patent Literature 1 considers only one of forward and backward reference images. The most similar block may possibly exist in the reference image that was not considered. In this sense, also, the determined block is not necessarily most similar to the object block to be coded.

In general, as the similarity between the determined block and the object block to be coded is lower, the information amount required for coding of difference image information is greater. Therefore, although being effective for reduction in the computation amount required for coding, the method described above is not necessarily satisfactory in coding efficiency.

### SUMMARY OF THE INVENTION

An object of the present invention is providing a motion vector search method and apparatus in which the coding efficiency of bidirectionally predictive coded images (so-called B pictures) can be improved.

The motion vector search method of the present invention is a motion vector search method for searching for a motion vector for each of object blocks to be coded constituting an object frame to be coded in execution of motion compensated interframe predictive coding of a moving image signal using two or more reference frames including a first reference frame and a second reference frame, the method comprising the steps of:

searching for a first motion vector based on a block retrieved from the first reference frame (first motion vector search step);

searching for a second motion vector based on a block retrieved from the second reference frame (second motion vector search step);

determining a combination of a block in the first reference frame and a block in the second reference frame so that the correlation of an averaged block of a block retrieved from the first reference frame and a block retrieved from the second reference frame with the object block is the highest, and searching for a motion vector pair based on the determined combination (third motion vector search step); and

selecting any among the first and second motion vectors and the motion vector pair (motion vector selection step).

Alternatively, the motion vector search method of the present invention is a motion vector search method for searching for a motion vector for each of object blocks to be coded constituting an object frame to be coded in execution of motion compensated interframe predictive coding of a moving image signal using two or more reference frames including a first reference frame and a second reference frame, the method comprising the steps of:

searching for a first motion vector based on a block retrieved from the first reference frame (first motion vector search step);

searching for a second motion vector based on a block retrieved from the second reference frame (second motion vector search step);

determining a combination of a block in the first reference frame and a block in the is second reference frame so that the correlation of an averaged block of a block retrieved from the first reference frame and a block retrieved from the second reference frame with the object block is the highest, and searching for a motion vector pair based on the determined combination (third motion vector search step);

deciding whether or not processing in the third motion vector search step is to be performed by evaluating the effectiveness of the third motion vector search step (decision step); and

selecting any among the first and second motion vectors and the motion vector pair if the processing in the third motion vector search step has been performed, or selecting one of the first and second motion vectors if the processing in the third motion vector search step has not been performed (motion vector selection step).

Alternatively, the motion vector search method of the present invention is a motion vector search method for searching for a motion vector for each of object blocks to be coded constituting an object frame to be coded in execution of motion compensated interframe predictive coding of a moving image signal using two or more reference frames including a first reference frame and a second reference frame, the method comprising the steps of:

selecting either one of the first reference frame and the second reference frame (search direction determination step);

searching for a first motion vector based on a block retrieved from the reference frame selected in the search direction determination step (first motion vector search step);

searching for a second motion vector based on a block retrieved from the other reference frame not selected in the search direction determination step, and simultaneously determining a block in the other reference frame so that the correlation of an averaged block of a block corresponding to the first motion vector and a block retrieved from the other reference frame with the object block is the highest and searching for a third motion vector based on the determined block to obtain a motion vector pair composed of the second and third motion vectors (motion vector pair search step); and

selecting any among the first and second motion vectors and the motion vector pair (motion vector selection step).

### BRIEF DESCRIPTION OF THE DRAWINGS

FIG. 1 is a flowchart illustrating a motion vector search method of Embodiment 1 of the present invention.

FIG. 2 is a view diagrammatically showing the relationship among a forward reference image, an object block to be coded and a backward reference image in Embodiment 1.

FIG. 3 is a flowchart showing an exemplary search procedure for the most similar forward block.

FIG. 4 is a flowchart showing an exemplary search procedure for the most similar bidirectional block.

FIG. 5 is a flowchart illustrating a motion vector search method of Embodiment 2 of the present invention.

FIG. 6 is a flowchart illustrating a motion vector search method of Embodiment 3 of the present invention.

FIG. 7 is a view showing an example of reference relationship among I pictures, P pictures and B pictures.

FIG. 8 is a flowchart illustrating a motion vector search method of Embodiment 4 of the present invention.

FIG. 9 is a view showing an example of selection of reference schemes in coded blocks surrounding an object block to be coded.

FIG. 10 is a flowchart illustrating a motion vector search method of Embodiment 5 of the present invention.

FIG. 11 is a flowchart illustrating a motion vector search method of Embodiment 6 of the present invention.

FIG. 12 is a flowchart illustrating a motion vector search method of Embodiment 7 of the present invention.

FIG. 13 is a flowchart illustrating a motion vector search method of Embodiment 8 of the present invention.

FIG. 14 is a flowchart illustrating a motion vector search method of Embodiment 9 of the present invention.

FIG. 15 is a flowchart illustrating a motion vector search method of Embodiment 10 of the present invention.

FIG. 16 is a flowchart illustrating a motion vector search method of Embodiment 11 of the present invention.

FIG. 17 is a flowchart illustrating a motion vector search method of Embodiment 12 of the present invention.

FIG. 18 is a flowchart illustrating a motion vector search method of Embodiment 13 of the present invention.

FIG. 19 is a flowchart illustrating a motion vector search method of Embodiment 14 of the present invention.

FIG. 20 is a flowchart illustrating a motion vector search method of Embodiment 15 of the present invention.

FIG. 21 is a flowchart illustrating a motion vector search method of Embodiment 16 of the present invention.

FIG. 22 is a flowchart illustrating a motion vector search method of Embodiment 17 of the present invention.

FIG. 23 is a flowchart illustrating simultaneous search of single-direction search and bidirectional motion vector search.

FIG. 24 is a flowchart illustrating a motion vector search method of Embodiment 18 of the present invention.

FIG. 25 is a block diagram of a motion vector search apparatus of Embodiment 19 of the present invention.

FIG. 26 is a block diagram of a motion vector search apparatus of Embodiment 20 of the present invention.

### DESCRIPTION OF THE PREFERRED EMBODIMENTS

Hereinafter, preferred embodiments of the present invention will be described with reference to the accompanying drawings.

### Embodiment 1

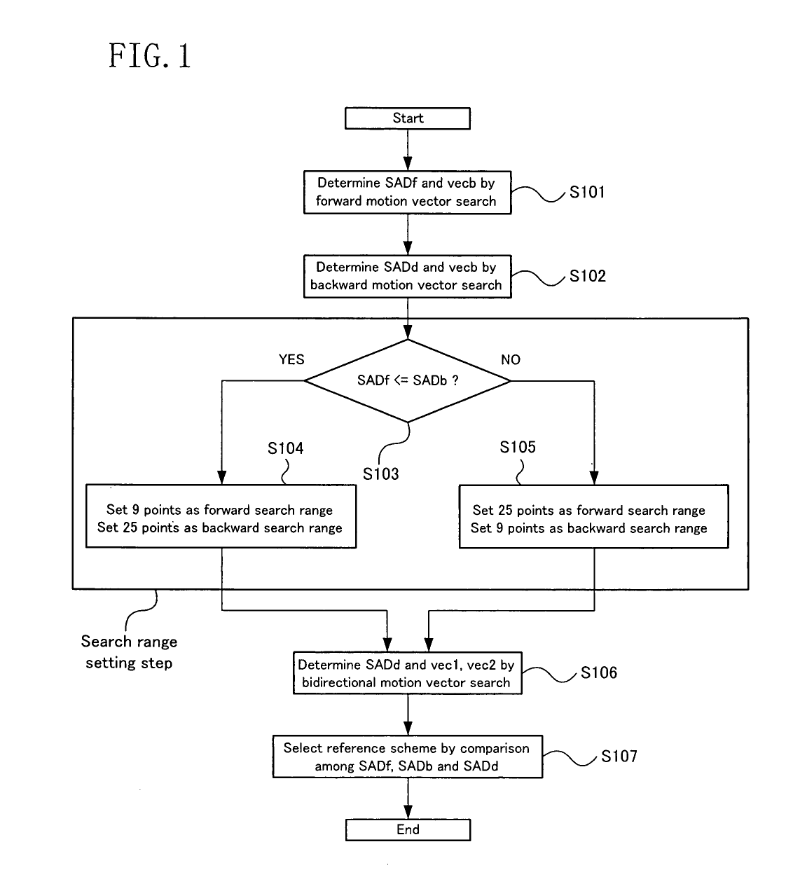

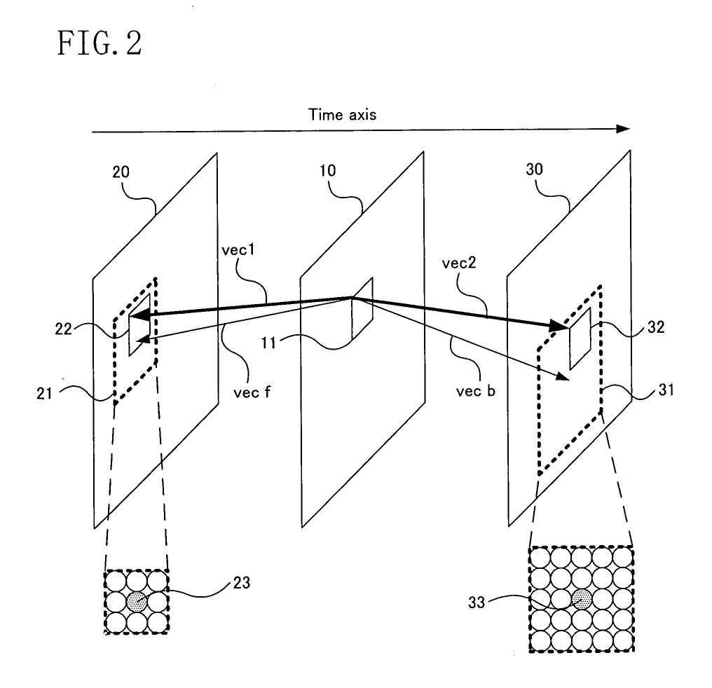

FIG. 1 is a flowchart illustrating a motion vector search method of Embodiment 1 of the present invention. FIG. 2 is a view diagrammatically showing the relationship among a forward reference image, an object image to be coded (object block to be coded) and a backward reference image in Embodiment 1. In FIG. 2, a block 11 in an object image 10 is the object block to be coded.

Processing in each step in the flowchart of FIG. 1 is as follows.

First, in S101 (forward motion vector search step), a block most similar to the object block 11 is searched for in a predetermined forward search range of a forward reference image 20, and the similarity SADf between the resultant most similar forward block and the object block 11, as well as a motion vector vecf therebetween, are determined. How to calculate the similarity between the blocks will be described later.

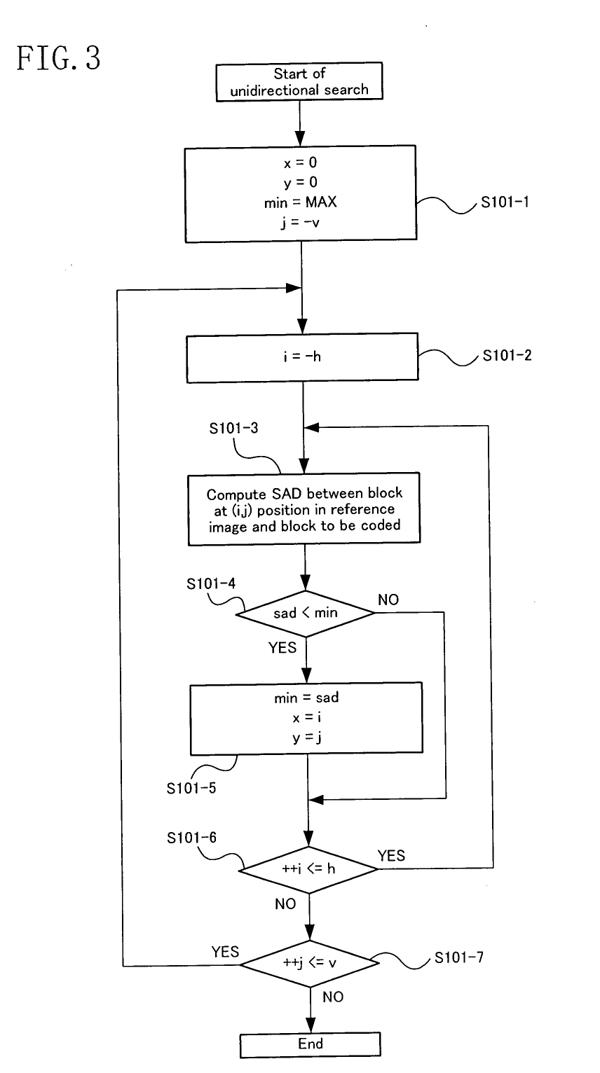

The search for the most similar forward block in S101 may follow the procedure shown in the flowchart of FIG. 3. Note that in FIG. 3, x and y denote variables holding the coordinate position of the most similar block, min denotes a variable holding the similarity of the most similar block, i and j respectively denote loop counters in the horizontal and vertical directions for repeating the processing over the search range, and sad denotes a variable temporarily holding the similarity at each search point. Note also that v and h in FIG. 3 respectively denote values indicating the sizes of the search range in the vertical and horizontal directions.

Hereinafter, processing in each step shown in FIG. 3 will be described.

S101-1 (Parameter initialization step)

In this step, first, x and y are initialized to 0, min is initialized to MAX, and j is initialized to −v, wherein MAX is the largest value allowed to assume as the similarity. In this embodiment, the sum of absolute differences (SAD) is used as the similarity between blocks (also called the block similarity or the degree of correlation). As the SAD value is smaller, the similarity between two blocks is higher. Specifically, the SAD value can be represented by the following equation.

SAD=Σ|a[j][i]−b[j][i]|

where a[j][i] and b[j][i] are pixel values of two blocks the similarity between which is to be determined.

S101-2 (Horizontal repeat count initialization step)

In this step, i is initialized to −h.

S101-3 (Similarity computation step)

In this step, the SAD value between a block indicated by a search point position (i, j) within the search range and the object block 11 is computed, and the result is stored in sad.

S101-4 (Highest similarity determination step)

In this step, sad determined in S101-3 is compared with min. The process proceeds to S101-5 if sad is smaller than min, or otherwise to S101-6.

S101-5 (Most similar block information hold step)

In this step, i and j are respectively stored in the holding variables x and y as the coordinate position of the most similar block. Also, the sad value is stored in min.

S11-6 (Horizontal repeat count determination step)

In this step, the horizontal loop counter i is incremented by 1, and the process returns to S101-3 if i is equal to or less than h, or otherwise proceeds to 101-7.

S101-7 (Vertical repeat count determination step)

In this step, the vertical loop counter j is incremented by 1, and the process returns to S101-2 if j is equal to or less than v, or otherwise is terminated.

With the processing in S101-1 to S101-7, a block giving the smallest SAD value is searched for in the search range having a total of (2h+1)×(2v+1) search points defined by four points (−h, −v), (−h, v), (h, −v) and (h, v). In the illustrated case, SADf=min, and motion vector vecf=(x, y).

In S102 (backward motion vector search step), a block most similar to the object block 11 is searched for in a predetermined backward search range of a backward reference image 30, and the similarity SADb between the resultant most similar backward block and a motion vector vecb, as well as the motion vector vecb, are determined. The search method for the most similar backward block in S102 is substantially the same as that in S101.

In S103 to S105 (these steps are collectively called a search range setting step), the search range to be used in S106 (bidirectional motion vector search step) to follow is set.

Specifically, in the search range setting step of this embodiment, the similarities determined in S101 and S102 are compared with each other, and the search range using the motion vector corresponding to the higher similarity is set narrower than the search range using the motion vector corresponding to the lower similarity.

To state more specifically, in S103 (similarity comparison step), SADf determined in S101 and SADb determined in S102 are compared with each other, and the process proceeds to S104 if SADf is equal to or less than SADb, or otherwise proceeds to S105.

In S104 (first bidirectional search range setting step), a search range (forward search range 21) narrower than a backward search range 31 is set in the forward reference image 20. In S105 (second bidirectional search range setting step), a search range (backward search range 31) narrower than the forward search range 21 is set in the backward reference image 30.

FIG. 2 illustrates the forward search range 21 and the backward search range 31 set when S104 is executed. In the illustrated example, set are the forward search range 21 having 9 search points with a search point position 23 indicated by the motion vector vecf being located at the center, and the backward search range 31 having 25 search points with a search point position 33 indicated by the motion vector vecb being located at the center.

The setting of the size of a search range, which represents the reliability of the motion vector related to the search of the SAD value, is based on the principle that a narrower search range can be set for a search of the surroundings of a motion vector higher in reliability.

In S106 (bidirectional motion vector search step), for generation of an averaged block most similar to the object block 11, each one block is taken from the forward search range 21 and the backward search range 31 to determine a motion vector pair (forward motion vector vec1 and backward motion vector vec2). Similarity SADd between the averaged block corresponding to the motion vector pair and the object block 11 is then determined. Assume that the two blocks (called a forward block and a backward block) used for generation of the averaged block are the most similar forward block 22 and the most similar backward block 32 in the example of FIG. 2.

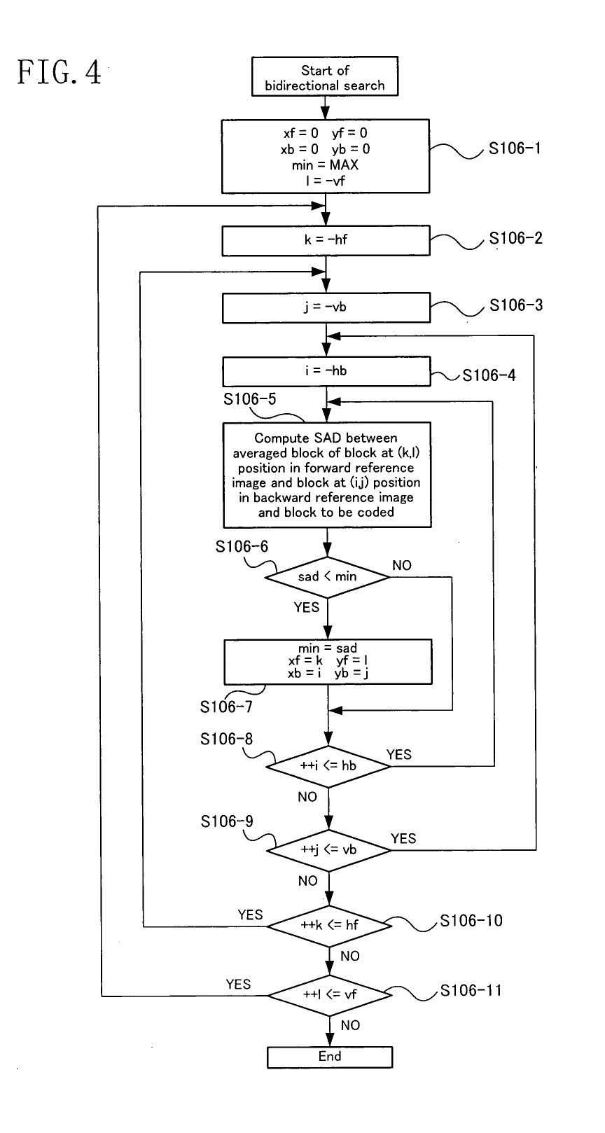

The search for the most similar bidirectional block in S106 may follow the procedure shown in the flowchart of FIG. 4. Note that in FIG. 4, xf and yf denote variables holding the coordinate position of the forward search result, xb and yb denote variables holding the coordinate position of the backward search result, min denotes a variable holding the similarity of the most similar block, i and j respectively denote loop counters in the horizontal and vertical directions for repeating processing over the backward search range, k and l respectively denote loop counters in the horizontal and vertical directions for repeating processing over the forward search range, and sad denotes a variable temporarily holding the similarity at each search point.

Hereinafter, processing in each step shown in FIG. 4 will be described.

S106-1 (Parameter initialization step)

In this step, xf, yf, xb and yb are initialized to 0, min is initialized to MAX, and l is initialized to −vf. Note that MAX is the largest value allowed to assume as the similarity, vf and hf are values indicating the sizes of the forward search range in the vertical and horizontal directions, and vb and hb are values indicating the sizes of the backward search range in the vertical and horizontal directions.

S106-2 to S106-4

Initialization of variables is also performed in S106-2 to S106-4. Specifically, k is initialized to −hf in S106-2 (forward horizontal repeat count initialization step), j is initialized to −vb in S106-3 (backward vertical repeat count initialization step), and i is initialized to −hb in S106-4 (backward horizontal repeat count initialization step).

S106-5 (Similarity computation step)

In this step, the SAD value is computed between an averaged block, determined from a reference block represented by the search point position (k, l) in the forward reference image 20 and a reference block represented by the search point position (i, j) in the backward reference image 30, and the object block 11, and the result is stored in sad.

S106-6 (Highest similarity determination step)

In this step, sad is compared with min. The process proceeds to S106-7 if sad is smaller than min, or otherwise to S106-8.

S106-7 (Most similar block information hold step)

In this step, the values of k and l are respectively stored in the holding variables xf and yf as the coordinate position of the forward block that is one of the two reference blocks generating the most similar block, while the values of i and j are respectively stored in the holding variables xb and yb as the coordinate position of the backward block that is the other reference block. Also, the value of sad is stored in min.

S106-8 (Backward horizontal repeat count determination step)

In this step, i (horizontal loop counter for the backward search range) is incremented by 1, and the process returns to S106-5 if i is equal to or less than hb, or otherwise proceeds to S106-9.

S106-9 (Backward vertical repeat count determination step)

In this step, j (vertical loop counter for the backward search range) is incremented by 1, and the process returns to S106-4 if j is equal to or less than vb, or otherwise proceeds to S106-10.

S106-10 (Forward horizontal repeat count determination step)

In this step, k (horizontal loop counter for the forward search range) is incremented by 1, and the process returns to S106-3 if k is equal to or less than hf, or otherwise proceeds to S106-11.

S106-11 (Forward vertical repeat count determination step)

In this step, l (vertical loop counter for the forward search range) is incremented by 1, and the process returns to S106-2 if l is equal to or less than vf, or otherwise is terminated.

With the above processing, two blocks giving the smallest SAD value is searched for from combinations (a total of (2hf+1)×(2vf+1)×(2hb+1)×(2vb+1)) of search points in the forward search range defined by four points (−hf, −vf), (−hf, vf), (hf, −vf) and (hf, vf) and search points in the backward search range defined by four points (−hb, −vb), (−hb, vb), (hb, −vb) and (hb, vb). In the illustrated case, SADd=min, forward motion vector vec1=(xf, yf), and backward motion vector vec2=(xb, yb).

In S107 (reference scheme selection step), the SAD values determined in S101, S102 and S106 are compared with one another. The reference scheme corresponding to the smallest SAD value is selected as the reference scheme for the object block 11.

As described above, in this embodiment, in which individual searches are made for forward reference, backward reference and bidirectional reference, and the optimum reference scheme is selected among these reference schemes, the coding efficiency for B pictures can be improved. With the improvement in coding efficiency, more room may become available in the recording space and be usable for recording of another image. As a result, improvement in image quality can be expected.

Also, in the bidirectional reference, the forward and backward search ranges (numbers of search points) are determined depending on the similarities (SAD values) in the forward reference and the backward reference. This permits efficient bidirectional motion vector search while reducing the number of search points.

### Embodiment 2

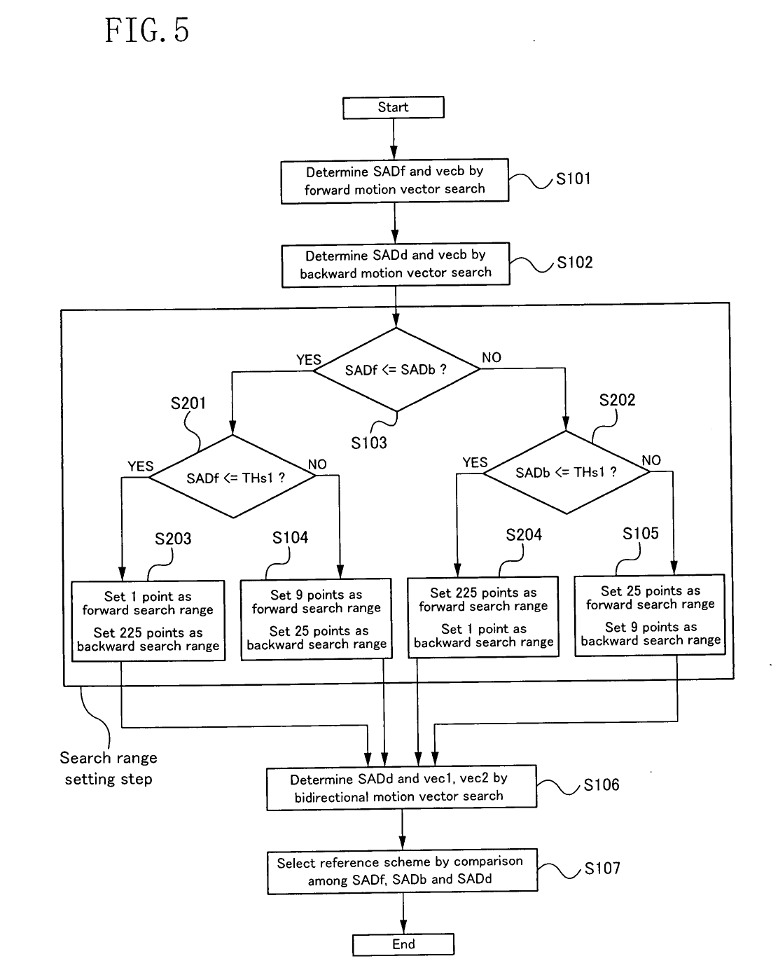

FIG. 5 is a flowchart illustrating a motion vector search method of Embodiment 2 of the present invention. As shown in the flowchart of FIG. 5, the motion vector search method of this embodiment is different from that of Embodiment 1 (FIG. 1) in the processing in the search range setting step. Specifically, steps S201 to S204 are newly added. Note that in this and subsequent embodiments, a step for executing substantially the same processing as that in any of the steps already discussed is denoted by the same step number, and description of such a step is omitted.

Processing in each of the new steps in the search range setting step in this embodiment is as follows.

S201 (First similarity threshold determination step)

In this step, the similarity SADf is compared with a similarity threshold THs1, and the process proceeds to S203 if SADf is equal to or less than THs1, or otherwise proceeds to S104.

S202 (Second similarity threshold determination step)

In this step, the similarity SADb is compared with the similarity threshold THs1, and the process proceeds to S204 if SADb is equal to or less than THs1, or otherwise proceeds to S105.

S203 (First bidirectional search range setting step)

In this step, one point is set as the forward search range and 225 points are set as the backward search range. In S106, therefore, no forward motion vector search is made, but forward motion vector vec1=motion vector vecf. The backward search range is set wide compared with that in S104. In this case, hf=vf=1 and hb=vb=15 (refer to FIG. 4 for hf and the like).

S204 (Second bidirectional search range setting step)

In this step, like S203, the backward search range is fixed to one point while the forward search range is set wide compared with that in S105. In this embodiment, 225 points are set as the forward search range.

Once the search ranges are set in the search range setting step, the bidirectional reference is performed in S106. In this step, in the search range composed of only one search point (i.e., having a motion vector high in the reliability of the search result), the one point is used for generation of the averaged block.

In the search range setting step in this embodiment, the forward search range and the backward search range are set after the determination in S103 on which is more reliable, the forward reference or the backward reference, based on the similarities. More specifically, the search range for a more reliable reference is set narrower than the other search range. Moreover, the size of the search range is set smaller as the similarity is higher.

As described above, in this embodiment, in which the search ranges in the bidirectional reference are set according to the similarities in the forward reference and the backward reference, efficient search can be made compared with the search method of Embodiment 1.

### Embodiment 3

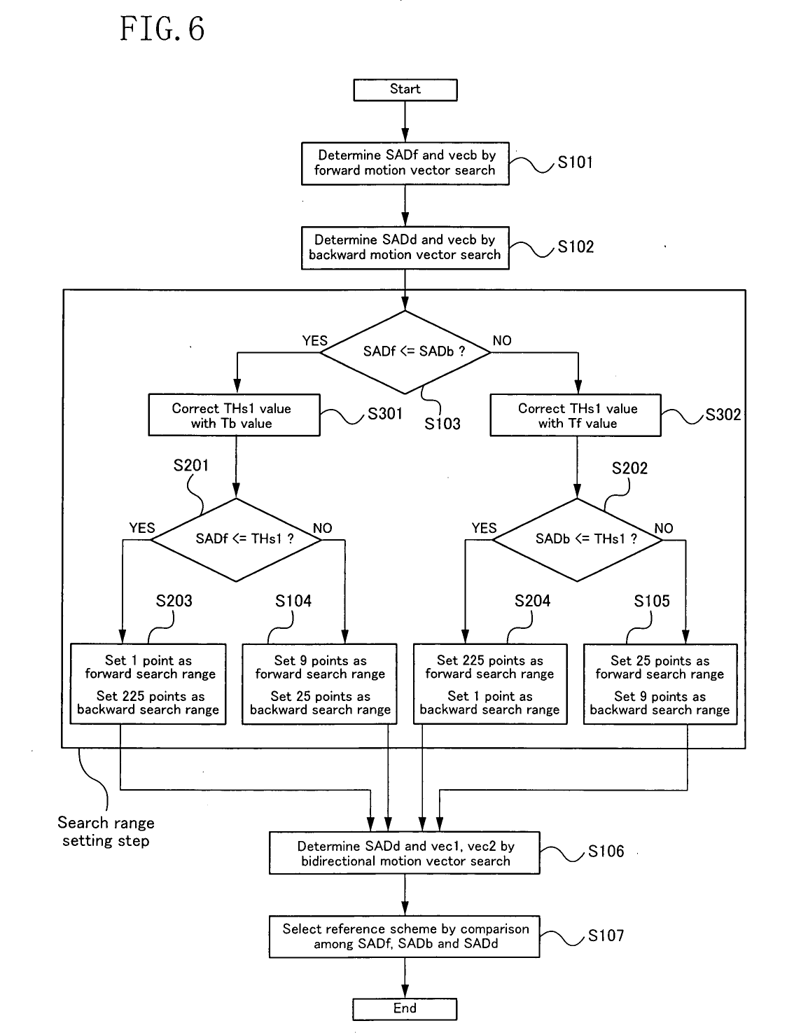

FIG. 6 is a flowchart illustrating a motion vector search method of Embodiment 3 of the present invention. As shown in the flowchart of FIG. 6, the motion vector search method of this embodiment is different from that of Embodiment 2 (FIG. 5) in the processing in the search range setting step. Specifically, steps S301 and S302 are newly added. Processing in each of the newly added steps is as follows.

S301 (First similarity threshold correction step)

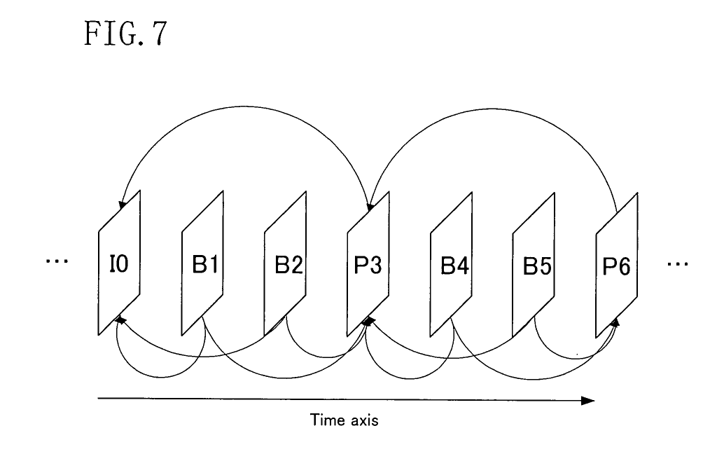

In this step, the value of the similarity threshold THs1 is changed with the value of a time-axis distance Tb, and then the process proceeds to S201. The time-axis distance Tb as used herein refers to the time-axis distance between the object picture to be coded and a backward reference picture. For example, assume that there is a reference relationship as shown in FIG. 7 among I pictures, P pictures and B pictures. In FIG. 7, I0 is an I picture, B1, B2, B4 and B5 are B pictures, and P3 and P6 are P pictures. In this case, Tb=2 in pictures B1 and B4, and Tb=1 in pictures B2 and B5. In this step, the value of the similarity threshold THs1 is changed so that the search range is wider as the time-axis distance to the backward reference picture is longer.

S302 (Second similarity threshold correction step)

In this step, the value of the similarity threshold THs1 is changed with the value of a time-axis distance Tf, and then the process proceeds to S202. The time-axis distance Tf as used herein refers to the time-axis distance between the object picture and the forward reference picture. In the example of FIG. 7, Tf=1 in pictures B1 and B4, and Tf=2 in pictures B2 and B5. In this step, the value of the similarity threshold THs1 is changed so that the search range is wider as the time-axis distance to the forward reference picture is longer.

How to change the similarity threshold THs1 in S301 and S302 will be described in a specific way.

If three B pictures are inserted between two reference pictures, Tb=1, 2 and 3 in the respective B pictures. Assume in this embodiment that the similarity threshold THs1 has been initialized so that the backward search range is optimal when Tb=2.

In this embodiment, in the case of execution of S301, if Tb=3, which means that the time-axis distance between the object picture and the backward reference picture is longer than that when Tb=2, the backward search range is set wider. To practically widen the backward search range, the similarity threshold THs1 is changed to a larger value.

If Tb=1, which means that the time-axis distance between the object picture and the backward reference picture is shorter than that when Tb=2, it is unnecessary to set the backward search range so wide. The similarity threshold THs1 is therefore changed to a smaller value.

As described above, in this embodiment, the size of the search range in the bidirectional reference is determined with the time-axis distance. This permits further efficient bidirectional motion vector search compared with the search method of Embodiment 2.

The search method of this embodiment can be applied irrespective of the number of B pictures inserted between two reference pictures, although three B pictures were inserted between two reference pictures in the above example. If five B pictures are inserted, for example, the decrease amount of the similarity threshold THs1 may be changed between when Tb=1 and when Tb=2.

### Embodiment 4

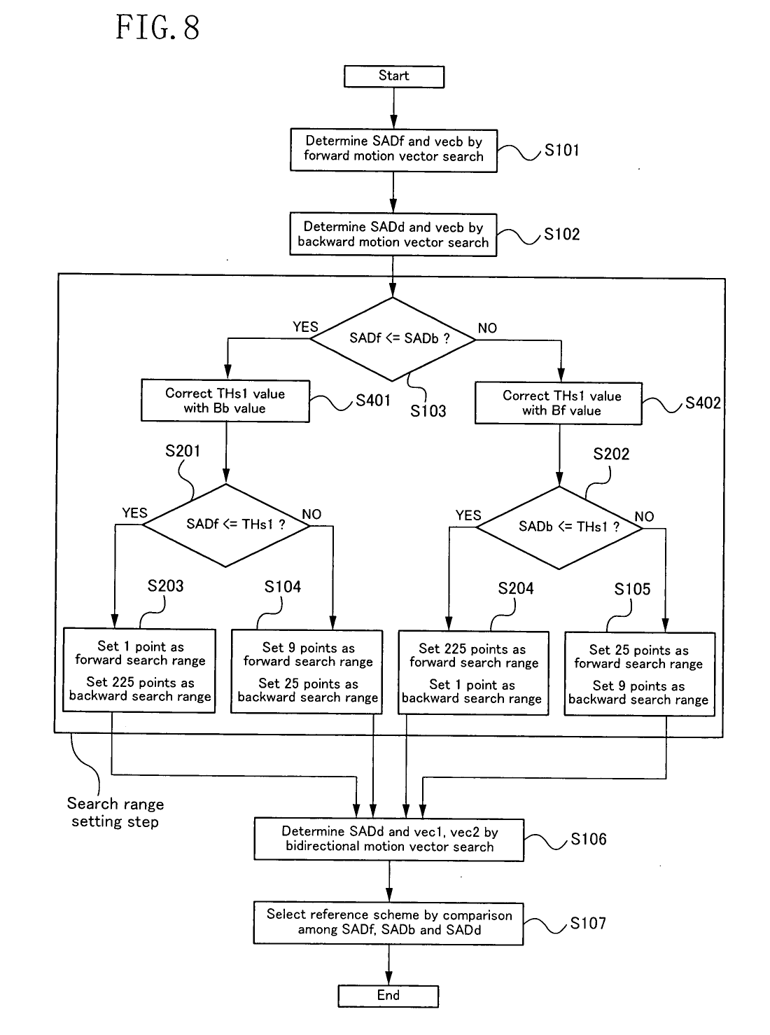

FIG. 8 is a flowchart illustrating a motion vector search method of Embodiment 4 of the present invention. As shown in the flowchart of FIG. 8, the motion vector search method of this embodiment is different from that of Embodiment 3 (FIG. 6) in the processing in the search range setting step. Specifically, steps S401 and S402 respectively replace S301 and S302. Processing in the new steps is as follows.

S401 (First similarity threshold correction step)

In this step, the value of the similarity threshold THs1 is changed with the value of the backward reference scheme count Bb (described later), and then the process proceeds to S201.

The backward reference scheme count Bb is the number of blocks coded using the backward reference, among coded blocks surrounding the object block to be coded. In this step, the value of the similarity threshold THs1 is changed so that the backward search range is set narrower as the backward reference scheme count Bb is larger.

S402 (Second similarity threshold correction step)

In this step, the value of the similarity threshold THs1 is changed with the value of the forward reference scheme count Bf (described later), and then the process proceeds to S202.

The forward reference scheme count Bf is the number of blocks coded using the forward reference, among coded blocks surrounding the object block to be coded. In this step, the value of the similarity threshold THs1 is changed so that the forward search range is set narrower as the forward reference scheme count Bf is larger.

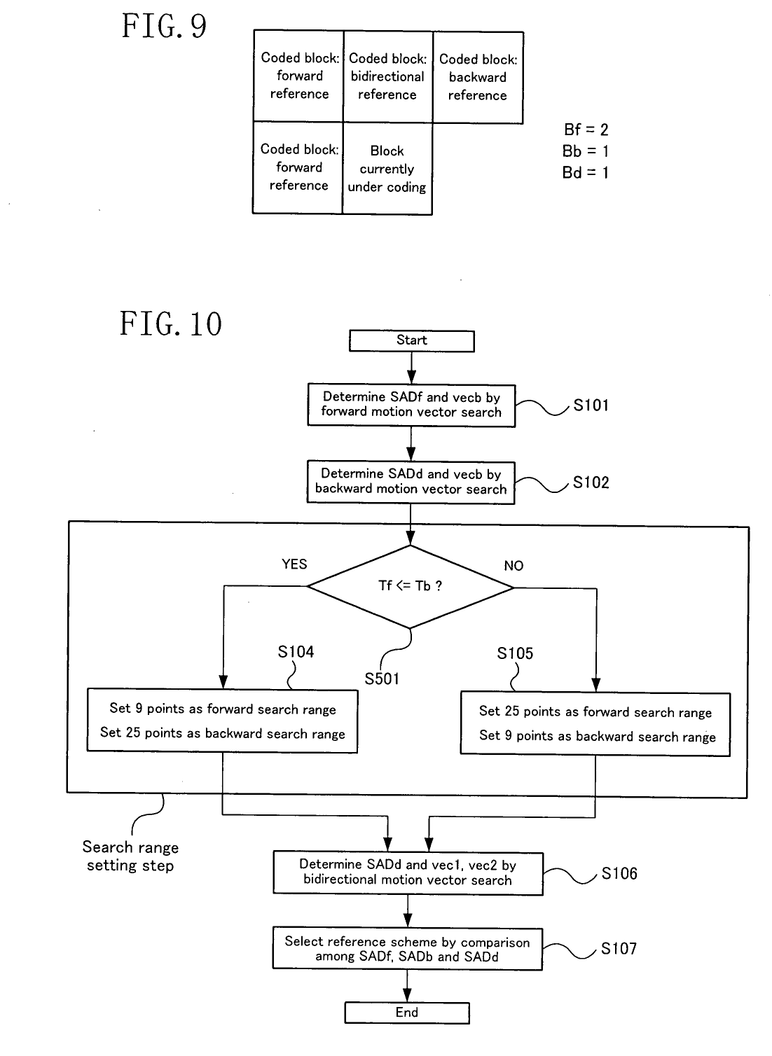

FIG. 9 shows an example of selection of reference schemes in coded blocks surrounding the object block. In the example of FIG. 9, Bf=2 and Bb=1.

How to change the similarity threshold THs1 in S401 and S402 will be described in a specific way.

If there are four coded blocks surrounding the object block, Bb will be any of 0, 1, 2, 3 and 4. Assume in this embodiment that the similarity threshold voltage THs1 has been initialized so that the backward search range is optimal when Bb=2.

In the case of execution of S401, if Bb=0 or 1, which means that the reliability of the backward reference motion vector is lower than when Bb=2, it is necessary to set the backward search range wider. To practically widen the backward search range, the similarity threshold THs1 is changed to a larger value.

If Bb=3 or 4, which means that the reliability of the backward reference motion vector is higher than when Bb=2, it is unnecessary to set the backward search range so wide. The similarity threshold THs1 is therefore changed to a smaller value.

As described above, in this embodiment, the size of the search range in the bidirectional reference is determined with the reference schemes adopted in coded blocks. This permits further efficient bidirectional motion vector search compared with the search method of Embodiment 2.

Although the cases when Bb=0 and when Bb=1 were regarded as equivalent in this embodiment, the increase amount of the similarity threshold THs1 may be changed between when Bb=0 and when Bb=1.

### Embodiment 5

FIG. 10 is a flowchart illustrating a motion vector search method of Embodiment 5 of the present invention. As shown in the flowchart of FIG. 10, the motion vector search method of this embodiment is different from that of Embodiment 1 (FIG. 1) in the processing in the search range setting step. Specifically, step S501 replaces S103. Processing in the new step is as follows.

S501 (Time-axis distance comparison step)

In this step, the time-axis distances Tf and Tb are compared with each other, and the process proceeds to S104 if Tf is equal to or less than Tb, or otherwise proceeds to S105.

That is, in this embodiment, in the bidirectional reference, a narrower search range is set for a reference picture that is shorter in the time-axis distance from the object picture. This setting of the search range is based on the principle that the range within which an object moves is narrower as the time-axis distance is shorter.

Thus, this embodiment also permits efficient bidirectional search while reducing the number of search points.

### Embodiment 6

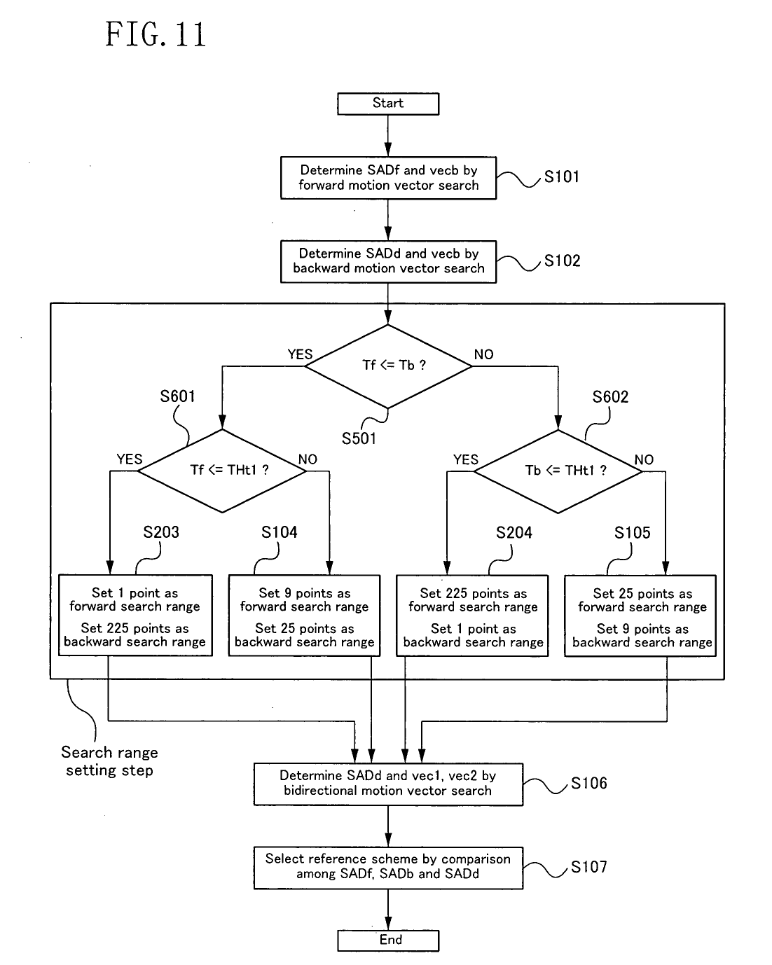

FIG. 11 is a flowchart illustrating a motion vector search method of Embodiment 6 of the present invention. As shown in the flowchart of FIG. 11, the motion vector search method of this embodiment is different from that of Embodiment 2 (FIG. 5) in the processing in the search range setting step. Specifically, step S501 replaces step S103, and new steps 601 and 602 respectively replace steps S201 and S202. Processing in the new steps is as follows.

S601 (First time-axis distance threshold determination step)

In this step, the time-axis distance Tf is compared with a time-axis distance threshold THt1, and the process proceeds to S203 if Tf is equal to or less than THt1, or otherwise proceeds to S104.

S602 (Second time-axis distance threshold determination step)

In this step, the time-axis distance Tb is compared with the time-axis distance threshold THt1, and the process proceeds to S204 if Tb is equal to or less than THt1, or otherwise proceeds to S105.

That is, in this embodiment, in the bidirectional reference, the search range of one of the reference pictures that is shorter in the time-axis distance from the object picture is set narrower than the search range of the other reference picture. Furthermore, if the time-axis distance for which the search range is made narrower is equal to or less than the time-axis distance threshold THt1, the search range is set at only one point (i.e., no motion vector search is performed in the reference picture having the narrower search range).

Thus, this embodiment permits further efficient bidirectional motion vector search compared with the motion vector search method of Embodiment 5.

### Embodiment 7

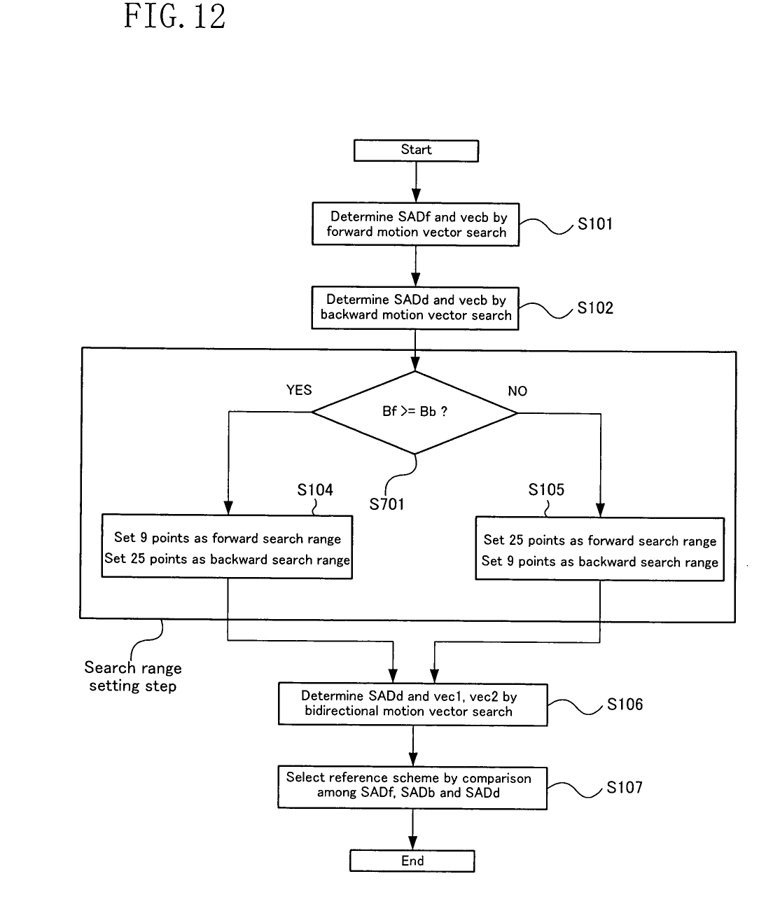

FIG. 12 is a flowchart illustrating a motion vector search method of Embodiment 7 of the present invention. As shown in the flowchart of FIG. 12, the motion vector search method of this embodiment is different from that of Embodiment 1 (FIG. 1) in the processing in the search range setting step. Specifically, step S701 (reference scheme count comparison step) replaces S103 (similarity comparison step).

In S701, the forward reference scheme count Bf and the backward reference scheme count Bb are compared with each other, and the process proceeds to S104 if Bf is equal to or more than Bb, or otherwise proceeds to S105.

That is, in this embodiment, in the bidirectional reference, the forward search range is made narrower than the backward search range if the number of blocks adopting the forward reference scheme is larger than the number of blocks adopting the backward reference scheme in the surroundings of the object block. In reverse, the backward search range is made narrower than the forward search range if the number of blocks adopting the backward reference scheme is larger than the number of blocks adopting the forward reference scheme around the object block.

The above setting is based on the principle that as a given reference scheme is selected in a larger number of neighboring coded blocks, the motion vector adopting the given reference scheme is higher in reliability.

As described above, this embodiment also permits efficient bidirectional motion vector search while reducing the number of search points.

### Embodiment 8

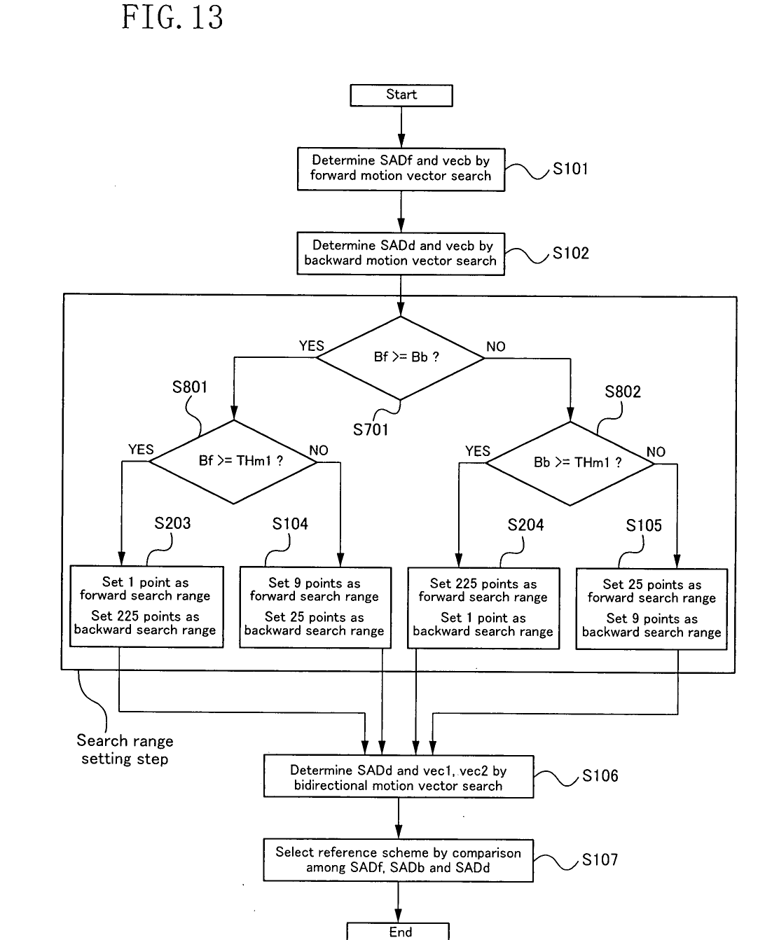

FIG. 13 is a flowchart illustrating a motion vector search method of Embodiment 8 of the present invention. As shown in the flowchart of FIG. 13, the motion vector search method of this embodiment is different from that of Embodiment 2 (FIG. 5) in the processing in the search range setting step. Specifically, step S701 (reference scheme count comparison step) replaces step S103, and new steps S801 and S802 respectively replace steps S201 and S202. Processing in the new steps is as follows.

S801 (First reference scheme count threshold determination step)

In this step, the forward reference scheme count Bf is compared with a reference scheme count threshold THm1, and the process proceeds to S203 if Bf is equal to or less than THm1, or otherwise proceeds to S104.

S802 (Second reference scheme count threshold determination step)

In this step, the backward reference scheme count Bb is compared with the reference scheme count threshold THm1, and the process proceeds to S204 if Bb is equal to or less than THm1, or otherwise proceeds to S105.

That is, in this embodiment, in the bidirectional reference, which search range, forward or backward, should be made narrower is determined depending on the numbers of blocks selecting the respective reference schemes in the surroundings of the object block. Furthermore, if the reference scheme count for which the search range is made narrower is equal to or less than the reference scheme count threshold THm1, the search range is set at only one point (i.e., no motion vector search is performed in the reference picture having the narrower search range).

Thus, this embodiment permits further efficient bidirectional motion vector search compared with the motion vector search method of Embodiment 7.

### Embodiment 9

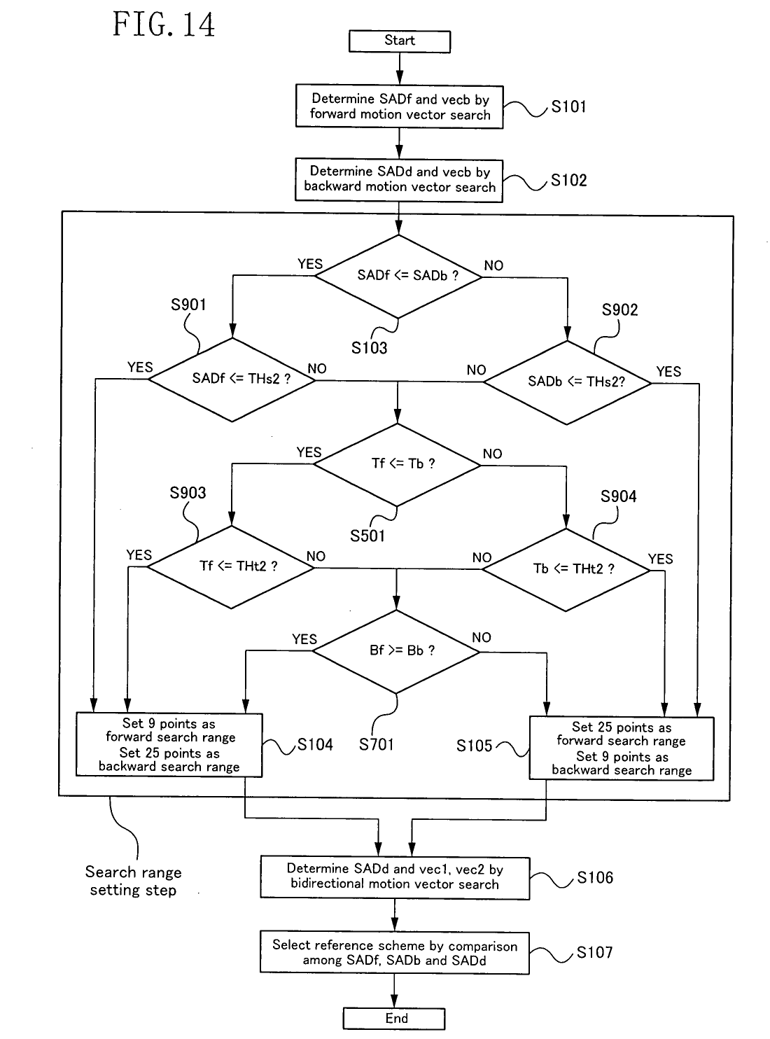

FIG. 14 is a flowchart illustrating a motion vector search method of Embodiment 9 of the present invention. The motion vector search method of this embodiment is different from that of Embodiment 5 (FIG. 10) in the processing in the search range setting step. Specifically, the search range setting step in this embodiment includes S103, S104, S105, S501, S701, and S901 to S904. Processing in the new steps S901 to S904 is as follows.

S901 (First similarity threshold determination step)

In this step, the similarity SADf is compared with a similarity threshold THs2, and the process proceeds to S104 if SADf is equal to or less than THs2, or otherwise proceeds to S501.

S902 (Second similarity threshold determination step)

In this step, the similarity SADb is compared with the similarity threshold THs2, and the process proceeds to S105 if SADb is equal to or less than THs2, or otherwise proceeds to S501.

S903 (First time-axis distance threshold determination step)

In this step, the time-axis distance Tf is compared with a time-axis distance threshold THt2, and the process proceeds to S104 if Tf is equal to or less than THt2, or otherwise proceeds to S701.

S904 (Second time-axis distance threshold determination step)

In this step, the time-axis distance Tb is compared with the time-axis distance threshold THt2, and the process proceeds to S105 if Tb is equal to or less than THt2, or otherwise proceeds to S701.

To state specifically, determination of the sizes of the search ranges is first attempted based on the similarity and the similarity threshold THs2. If this determination fails, the second attempt of determining the sizes of the search ranges is made based on the time-axis distance and the time-axis distance threshold THt2. If this determination also fails, the sizes of the search ranges are determined based on the numbers of blocks selecting the reference schemes in the surroundings of the object block.

That is, in this embodiment, in the bidirectional motion vector search, the search ranges are determined using jointly the similarities of unidirectional searches (forward motion vector search and backward motion vector search), the time-axis distances between the object picture and the reference images, and the numbers of blocks selecting the reference schemes in the surroundings of the object block. Thus, this embodiment permits further efficient bidirectional motion vector search compared with the motion vector search methods of Embodiments 1, 5 and 7.

### Embodiment 10

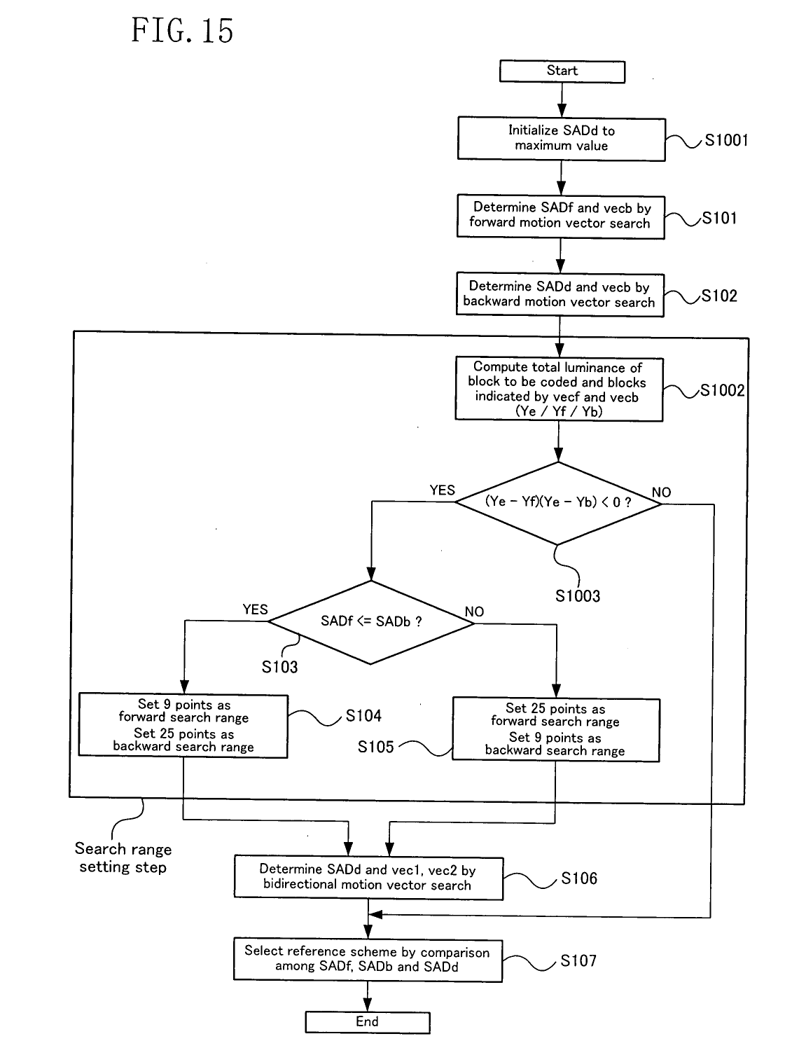

FIG. 15 is a flowchart illustrating a motion vector search method of Embodiment 10 of the present invention. The motion vector search method of this embodiment is different from that of Embodiment 1 (FIG. 1) in that steps S1001 to S1003 are additionally provided. Processing in the new steps S1001 to S1003 is as follows.

S1001 (Similarity initialization step)

In this step, the similarity SADd is initialized to the maximum (MAX) allowed to assume as the SAD value. This initialization is made to prevent SADd from being selected mistakenly in S107 in the case that it is decided in S1003 to perform no bidirectional motion vector search.

S1002 (Total luminance computation step)

In this step, computed are the total luminance Ye of pixels constituting the object block, the total luminance Yf of pixels constituting the forward reference block indicated by the motion vector vecf determined in S101, and the total luminance Yb of pixels constituting the backward reference block indicated by the motion vector vecb determined in S102. The process then proceeds to S1003.

S1003 (Total luminance determination step)

In this step, (Ye−Yf)×(Ye−Yb) is computed using Ye, Yf and Yb determined in the above step, and the result is compared with 0. The process proceeds to S103 if the result is less than 0, or otherwise proceeds to S107.

The reason for the processing in S1003 will be described. The expression (Ye−Yf)×(Ye−Yb) in S1003 will be a positive value if Ye>Yf and Ye>Yb or if Ye<Yf and Ye<Yb.

In the above case, the total luminance Ye of the object block won't be a value somewhere between the forward and backward block total luminance values Yf and Yb. Accordingly, even if the bidirectional motion vector search is performed in the surroundings of the forward and backward blocks, the possibility of obtaining a more optimal reference result than the forward reference or the backward reference is low. In this case, therefore, the process proceeds to S107 (reference scheme selection step) omitting the bidirectional motion vector search.

When (Ye−Yf)×(Ye−Yb) is a negative value, the total luminance Ye of the object block is a value somewhere between the total luminance values Yf and Yb. There is therefore a possibility that the reference result of the bidirectional motion vector search may be more optimal than the forward reference or the backward reference. In this case, therefore, the bidirectional motion vector search is performed.

As described above, in this embodiment, before execution of the bidirectional reference search, comparison is made among the pixel levels (total luminance values in the above example) of the object block, the block indicated by the forward motion vector and the block indicated by the backward motion vector, to examine the effectiveness of the bidirectional motion vector search. Only when being found effective, the bidirectional motion vector search is performed. Thus, this embodiment permits reduction in computation amount and reduction in power consumption without decreasing the coding efficiency.

Although the block total luminance was used in S1002 and S1003 in this embodiment, color difference information may be used as the pixel level in place of the block total luminance.

### Embodiment 11

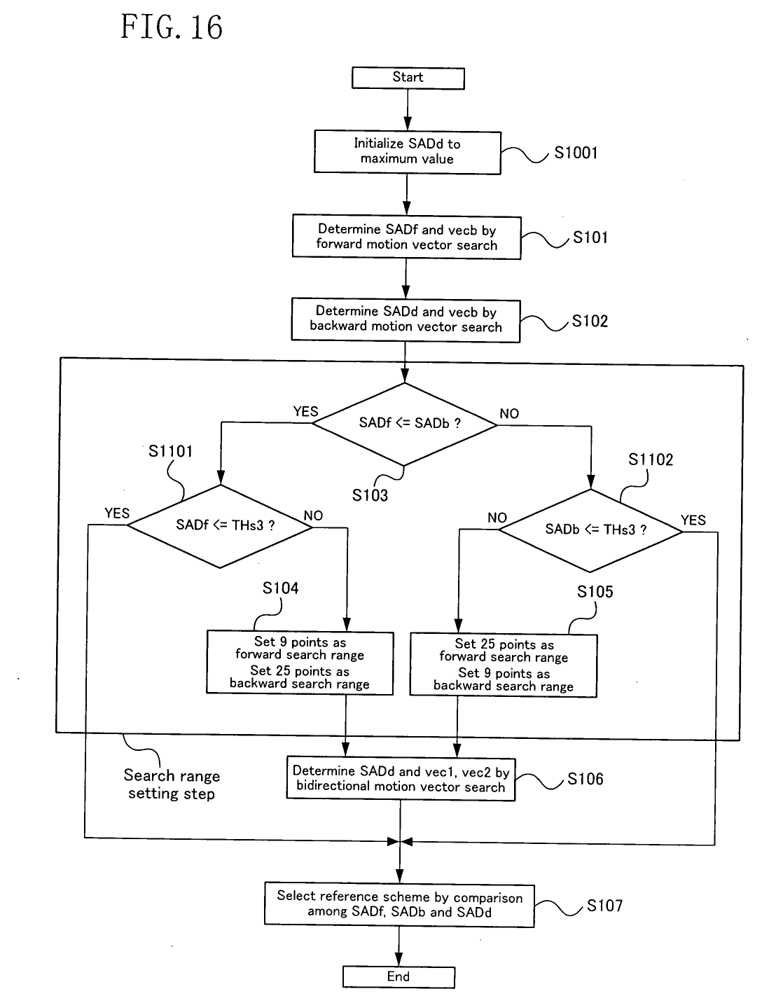

FIG. 16 is a flowchart illustrating a motion vector search method of Embodiment 1 of the present invention. The motion vector search method of this embodiment is different from that of Embodiment 1 (FIG. 1) in that steps S1001, S1101 and S1102 are additionally provided. Processing in the new steps S1101 and S1102 is as follows.

S1101 (First similarity threshold determination step)

In this step, the similarity SADf is compared with a similarity threshold THs3, and the process proceeds to S107 if SADf is equal to or less than THs3, or otherwise proceeds to S104.

S1102 (Second similarity threshold determination step)

In this step, the similarity SADb is compared with the similarity threshold THs3, and the process proceeds to S107 if SADf is equal to or less than THs3, or otherwise proceeds to S105.

As described above, in this embodiment, no bidirectional motion vector search is performed if the smaller one of the similarities (SAD values) determined in the forward and backward motion vector searches in S101 and S102 is equal to or less than the similarity threshold THs3 in S1101 and S1102.

Thus, with no bidirectional motion vector search being performed if a sufficiently good result is obtained in a unidirectional search, this embodiment permits reduction in computation amount and reduction in power consumption without decreasing the coding efficiency.

### Embodiment 12

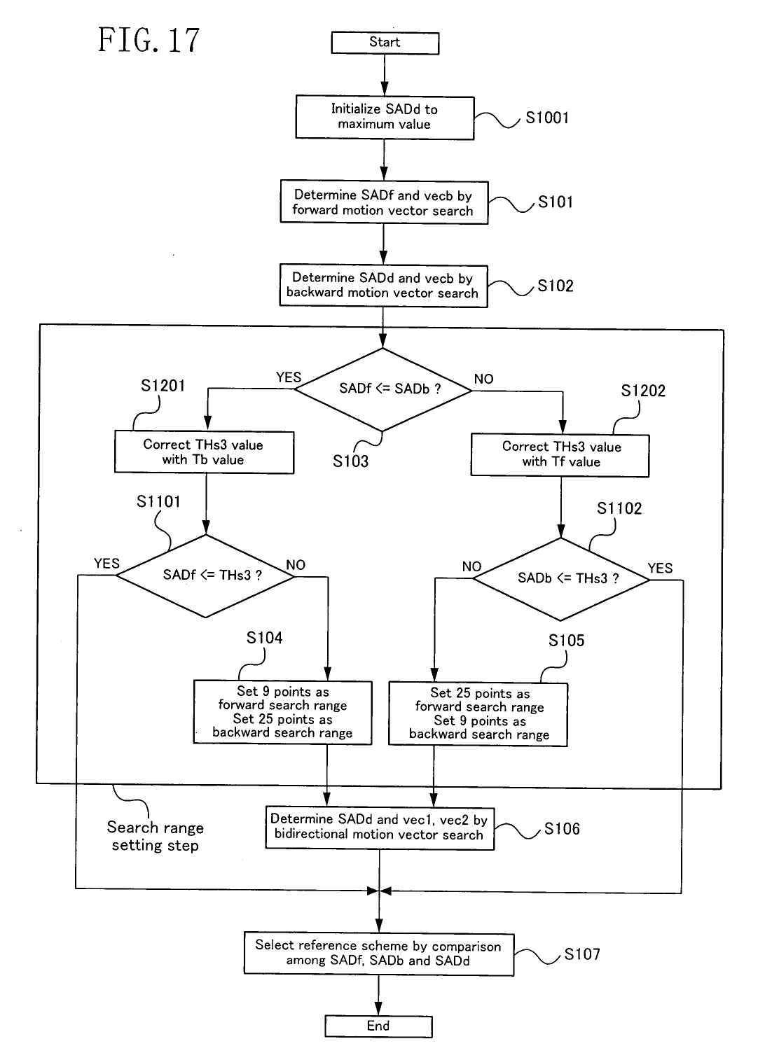

FIG. 17 is a flowchart illustrating a motion vector search method of Embodiment 12 of the present invention. The motion vector search method of this embodiment is different from that of Embodiment 11 (FIG. 16) in that S1201 and S1202 are additionally provided. Processing in S1201 and S1202 is as follows.

In S1201 (first similarity threshold correction step), the value of the similarity threshold THs3 is changed with the value of the time-axis distance Tb, and then the process proceeds to S1101.

In S1202 (second similarity threshold correction step), the value of the similarity threshold THs3 is changed with the value of the time-axis distance Tf, and then the process proceeds to S1102.

How to change the similarity threshold THs3 in S1201 and S1202 will be described taking as an example the case that three B pictures are inserted between two reference pictures and that S1201 is executed. In this case, Tb values of these B pictures are any of 1, 2 and 3. Assume in this embodiment that the similarity threshold voltage THs3 has been initialized so that the search range is optimal when Tb=2.

If Tb=1, which means that the time-axis distance between the object picture and the backward reference picture is short, the possibility that it may be unnecessary to perform the bidirectional motion vector search is high. The threshold THs3 is therefore corrected to a larger value.

If Tb=3, which means that the time-axis distance between the object picture and the backward reference picture is long, the possibility that it may be better to perform the bidirectional motion vector search is high. The threshold THs3 is therefore corrected to a smaller value.

As described above, in this embodiment, the threshold for deciding whether or not the bidirectional reference search should be performed is corrected with the time-axis distance. This permits further efficient bidirectional motion vector search compared with the motion vector search method of Embodiment 1.

The search method of this embodiment can be applied irrespective of the number of B pictures inserted between two reference pictures, although three B pictures were inserted between two reference pictures in the above example. If five B pictures are inserted, for example, the decrease amount of the similarity threshold THs3 may be changed between when Tb=1 and when Tb=2.

### Embodiment 13

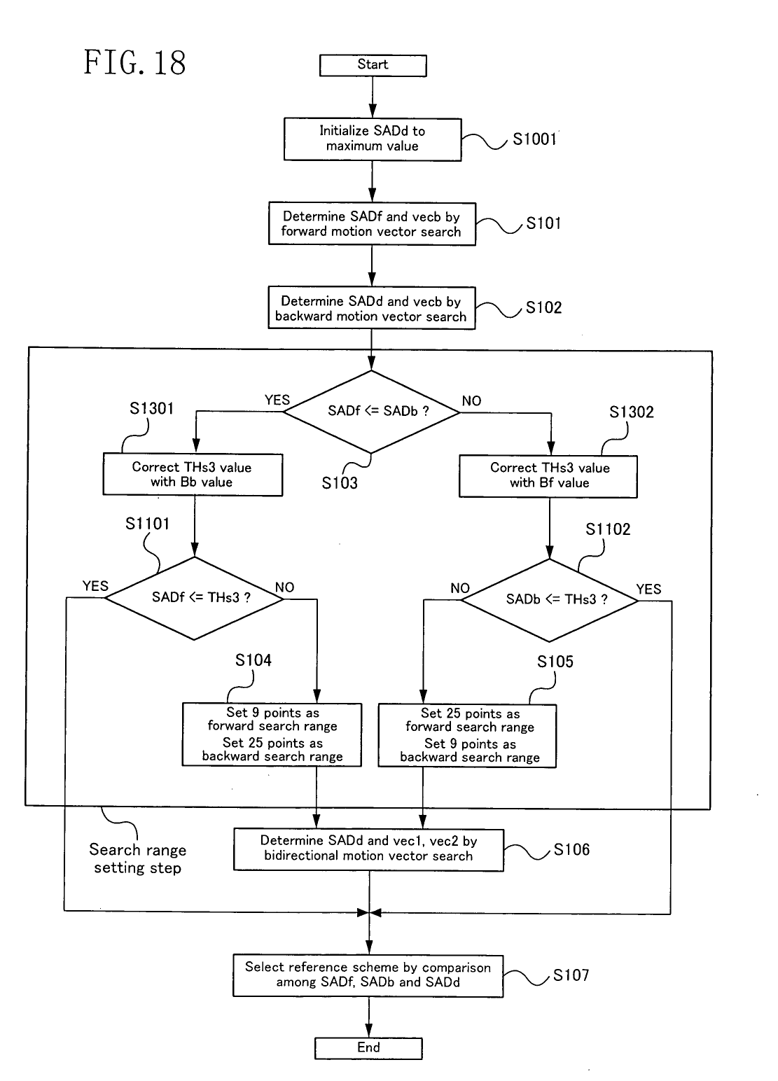

FIG. 18 is a flowchart illustrating a motion vector search method of Embodiment 13 of the present invention. The motion vector search method of this embodiment is different from that of Embodiment 12 (FIG. 17) in that S1301 and S1302 respectively replace S1201 and S1202. Processing in S1301 and S1302 is as follows.

In S1301 (first similarity threshold correction step), the value of the similarity threshold THs3 is changed with the value of the backward reference scheme count Bb, and the process proceeds to S1101.

In S1302 (second similarity threshold correction step), the value of the similarity threshold THs3 is changed with the forward reference scheme count Bf, and the process proceeds to S1102.

How to change the similarity threshold THs3 in S1301 and S1302 will be described taking as an example the case that there are four coded blocks surrounding the object block as shown in FIG. 9 and that S1301 is executed. In this case, Bb will be any of 0, 1, 2, 3 and 4. Assume in this embodiment that the similarity threshold voltage THs3 has been initialized so that the search range is optimal when Bb=2.

If Bb=3 or 4, which means that the reliability of the backward reference motion vector with respect to the object block is high, the possibility that it may be unnecessary to perform the bidirectional motion vector search is high. The threshold THs3 is therefore corrected to a larger value when Bb=3 or 4.

If Bb=0 or 1, which means that the reliability of the backward reference motion vector with respect to the object block is low, the possibility that it may be better to perform the bidirectional motion vector search is high. The threshold THs3 is therefore corrected to a smaller value when Bb=0 or 1.

As described above, in this embodiment, the threshold for deciding whether or not the bidirectional reference search should be performed is corrected with the reference schemes adopted in the neighboring blocks. This permits further efficient bidirectional motion vector search compared with the motion vector search method of Embodiment 11.

Although the same result was adopted for both when Bb=0 and when Bb=1 in this embodiment, the decrease amount of the value of THs3 may be changed between when Bb=0 and when Bb=1.

### Embodiment 14

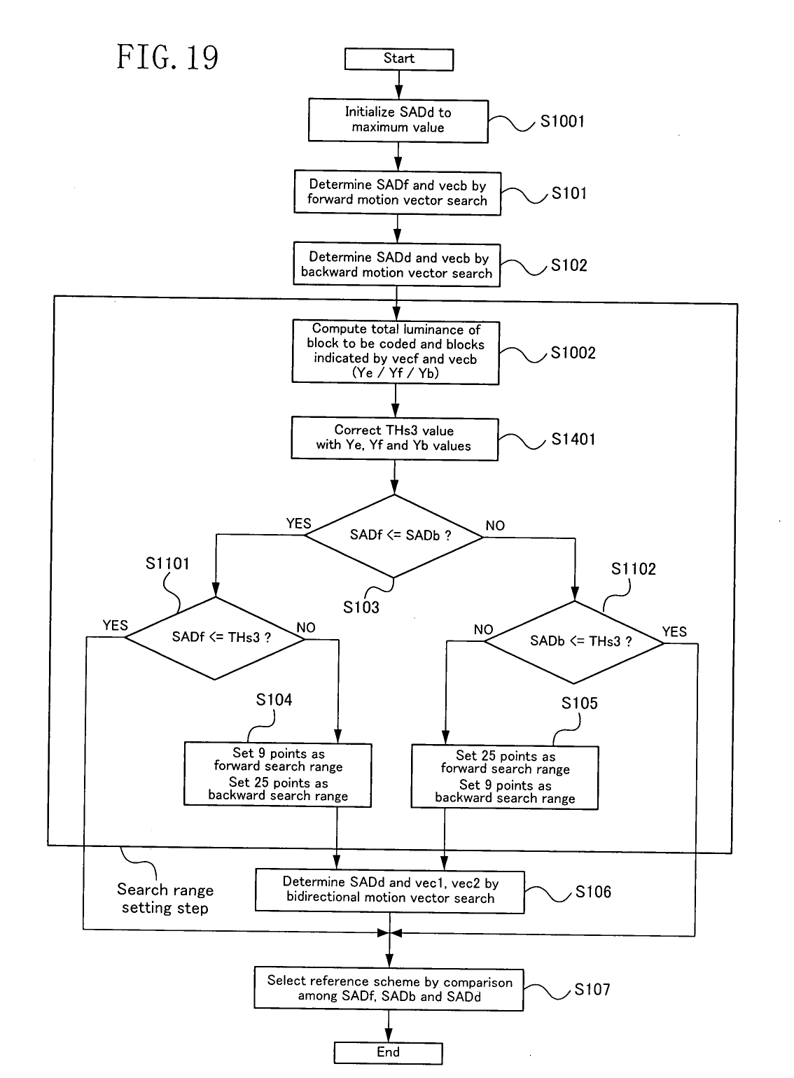

FIG. 19 is a flowchart illustrating a motion vector search method of Embodiment 14 of the present invention. The motion vector search method of this embodiment is different from that of Embodiment 11 (FIG. 16) in that S1002 and S1401 are additionally provided.

In the new step S1401 (similarity threshold correction step), the value of the threshold THs3 is changed with the values Ye, Yf and Yb computed in S1002, and then the process proceeds to S103.

How to change the similarity threshold THs3 in S1401 will be described. In S1401, as in Embodiment 10, (Ye−Yf)×(Ye−Yb) is computed, and the threshold is changed depending on whether the computation result is a positive value or a negative value.

For example, if the computation result is a positive value, the possibility that the bidirectional reference may provide a more optimal reference result than the forward reference or the backward reference is low. In this case, therefore, the value of THs3 is corrected to a larger value.

If the computation result is a negative value, the possibility that the bidirectional reference may provide a more optimal reference result than the forward reference or the backward reference is high. In this case, therefore, the value of THs3 is corrected to a smaller value.

As described above, in this embodiment, the threshold for deciding whether or not the bidirectional reference search should be performed is corrected with the total luminance. This permits further efficient bidirectional motion vector search compared with the motion vector search method of Embodiment 1.

In this embodiment, the threshold was changed only using the information on whether (Ye−Yf)×(Ye−Yb) is positive or negative. Alternatively, the absolute value information of (Ye−Yf)×(Ye−Yb) may be used to change the correction amount of THs3.

### Embodiment 15

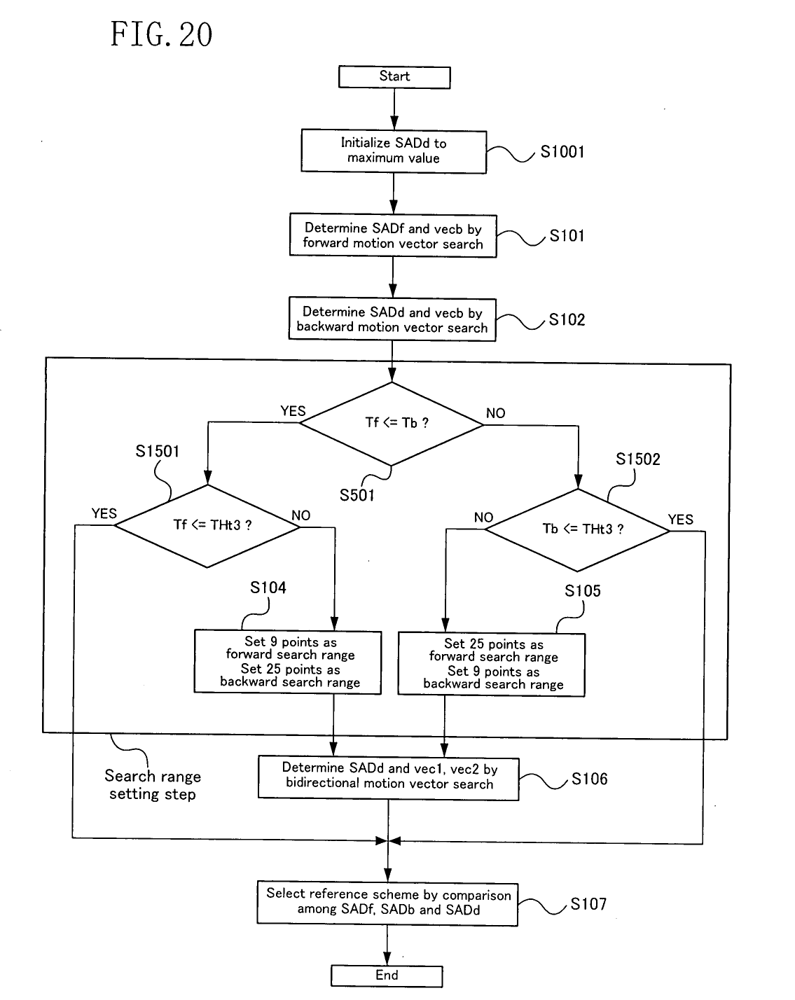

FIG. 20 is a flowchart illustrating a motion vector search method of Embodiment 15 of the present invention. The motion vector search method of this embodiment is different from that of Embodiment 11 (FIG. 16) in that step S501 replaces step S103, and new steps S1501 and S1502 respectively replace steps S1101 and S1102. Processing in S1501 and S1502 is as follows.

In S1501 (first time-axis distance threshold determination step), the time-axis distance Tf is compared with a time-axis distance threshold THt3, and the process proceeds to S107 if Tf is equal to or less than THt3, or otherwise proceeds to S104.

In S1502 (second time-axis distance threshold determination step), the time-axis distance Tb is compared with the time-axis distance threshold THt3, and the process proceeds to S107 if Tb is equal to or less than THt1, or otherwise proceeds to S105.

In S1501 and S1502 described above, the time-axis distance to the forward reference image or the time-axis distance to the backward reference image whichever is shorter is compared with the time-axis distance threshold THt3. If it is equal to or less than THt3, no bidirectional motion vector search is performed. In other words, if the time-axis distance to a reference image is sufficiently short, the bidirectional motion vector search is omitted and unidirectional search of the reference picture short in time-axis distance is performed. This embodiment therefore permits reduction in computation amount and reduction in power consumption without decreasing the coding efficiency.

### Embodiment 16

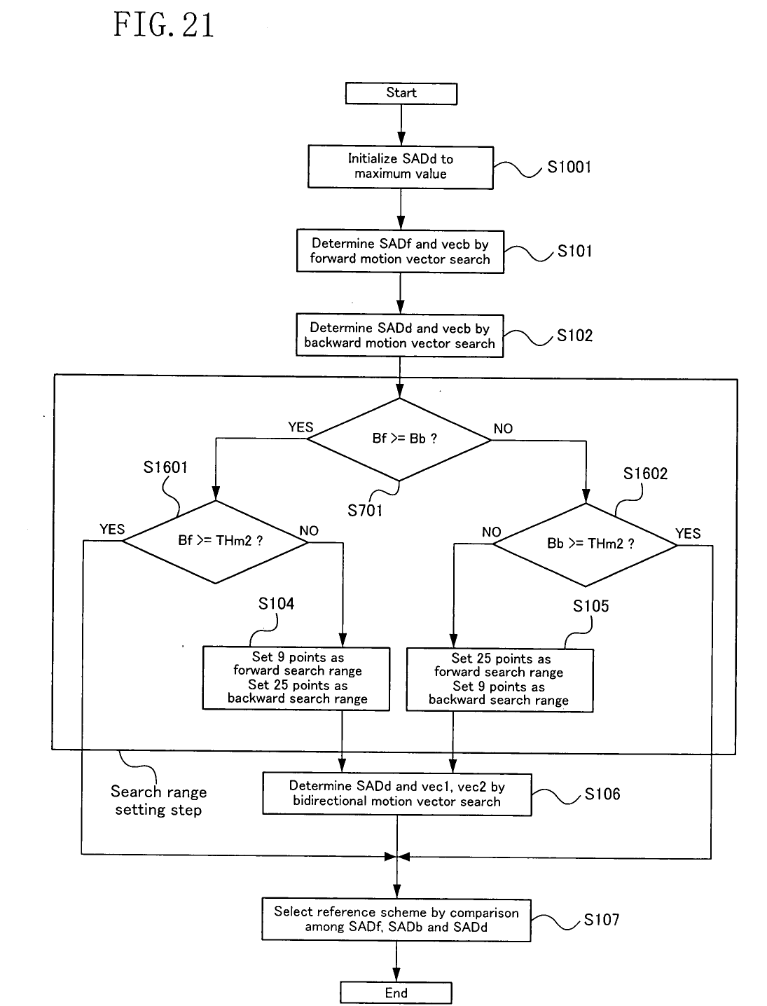

FIG. 21 is a flowchart illustrating a motion vector search method of Embodiment 16 of the present invention. The motion vector search method of this embodiment is different from that of Embodiment 11 (FIG. 16) in that step S701 replaces step S103, and new steps S1601 and S1602 respectively replace steps S1101 and S1102. Processing in S1601 and S1602 is as follows.

In S1601 (first reference scheme count threshold determination step), the forward reference scheme count Bf is compared with a reference scheme count threshold THm2, and the process proceeds to S104 if Bf is less than THm2, or otherwise proceeds to S107.

In S1602 (Second reference scheme count threshold determination step), the backward reference scheme count Bb is compared with the reference scheme count threshold THm2, and the process proceeds to S105 if Bb is less than THm2, or otherwise proceeds to S107.

In S1601 and S1602 described above, the number of blocks coded with the forward reference and the number of blocks coded with the backward reference, among coded blocks surrounding the object block, are determined. The larger one of the number of forward reference-coded blocks and the number of backward reference-coded blocks is then compared with the threshold. If the number is equal to or more than the threshold, no bidirectional motion vector search is performed. That is to say, if either the forward reference scheme or the backward reference scheme has been predominantly adopted in the surrounding blocks, no bidirectional reference will be performed. This embodiment therefore permits reduction in computation amount and reduction in power consumption without decreasing the coding efficiency.

### Embodiment 17

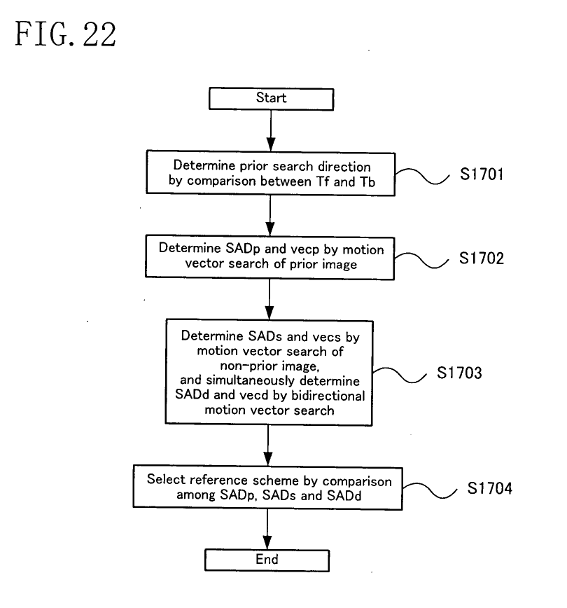

FIG. 22 is a flowchart illustrating a motion vector search method of Embodiment 17 of the present invention.

First, in S1701 (prior search direction determination step), the time-axis distances Tf and Tb are compared with each other, to determine a reference picture shorter in distance as the prior search image.

In S1702 (prior direction motion vector search step), the search range in the prior search image determined in S1701 is searched for a block most similar to the object block to be coded, to thereby determine a motion vector vecp and the smallest SAD value (SADp). The processing in this step is practically the same as the processing shown as the flowchart of FIG. 3.

In S1703 (non-prior direction/bidirectional motion vector simultaneous search step), the search range in the reference picture that has not been determined as the prior search image in S1701 (called the non-prior search image) is searched for a block most similar to the object block. Simultaneously, the bidirectional motion vector search processing is also performed (this simultaneous search will be detailed later). With this simultaneous search, obtained are a motion vector vecs and the smallest SAD value SADs as the search results of the non-prior search image, and a motion vector vecd and the smallest SAD value SADd as the bidirectional motion vector search results.

In S1704, the smallest SAD values obtained in S1702 and S1703 are compared with one another to select the smaller one, to thereby select the reference scheme for the object block.

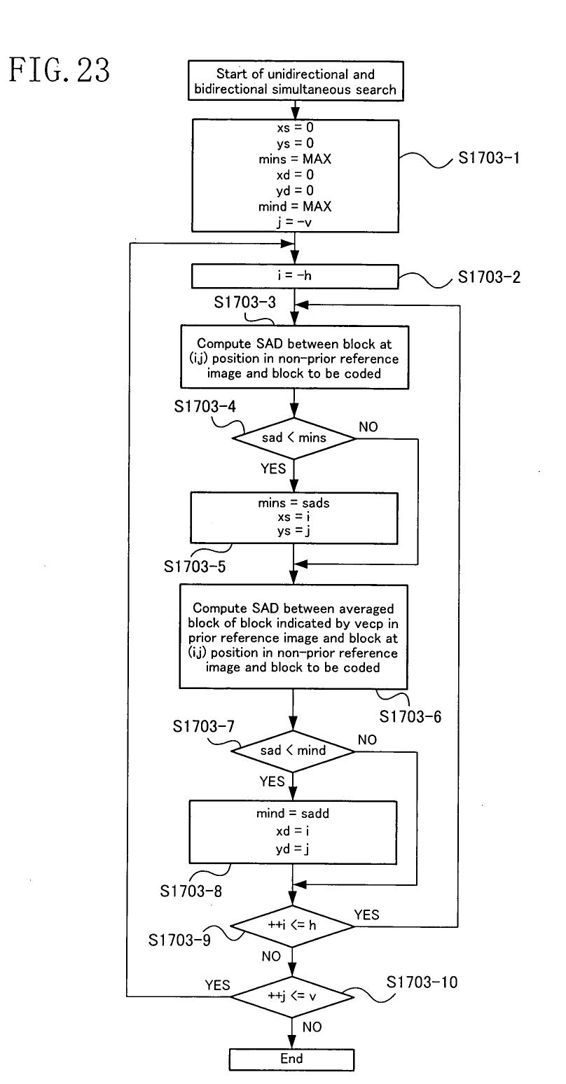

The simultaneous search in S1703 will be described. FIG. 23 is a flowchart illustrating the simultaneous search in S1703.

Note that in FIG. 23, xs and ys denote variables holding the coordinate position of the most similar block in the non-prior search image, xd and yd denote variables holding the coordinate position of a non-prior side block for generating the most similar block in the bidirectional motion vector search, mins denotes a variable holding the similarity of the most similar block in the non-prior search image, mind denotes a variable holding the similarity of the most similar block in the bidirectional motion vector search, i and j respectively denote loop counters in the horizontal and vertical directions for repeating processing over the search range, and sad denotes a variable temporarily holding the similarity at each search point.

Hereinafter, processing in each step will be described.

S1703-1 (parameter initialization step)

In this step, xs, ys, xd and yd are initialized to 0, mins and mind are initialized to MAX, and j is initialized to −v, wherein MAX is the largest value that can assume as the similarity, and v is a value indicating the size of the search range in the vertical direction. Incidentally, h is a value indicating the size of the search range in the horizontal direction.

S1703-2 (Horizontal repeat count initialization step)

In this step, i is initialized to −h.

S1703-3 (Unidirectional similarity computation step)

In this step, the SAD value between a reference block indicated by a search point position (i, j) and the object block is computed, and the computation result is stored in sad. The processing in this step is the same as that in S101-3 (similarity computation step) described in Embodiment 1, except that a block in the non-prior search image is used as the reference block.

S1703-4 (Unidirectional highest similarity determination step)

In this step, sad determined in S1703-3 is compared with mins in which the smallest SAD value obtained so far is held. The process proceeds to S1703-5 if sad is smaller than mins, or otherwise proceeds to S1703-6.

S1703-5 (Unidirectional most similar block information hold step)

In this step, i, j and sad are respectively stored in xs, ys and mins.

S1703-6 (Bidirectional similarity computation step)

In this step, the SAD value is computed between the object block and an averaged block determined from the most similar block obtained by the motion vector search of the prior search image and the reference block indicated by the search point position (i, j) in the non-prior search image, and the computation result is stored in sad.

The processing in this step is the same as that in S106-5 shown in the flowchart of FIG. 4, except that the most similar block determined in S1702 is invariably used as the block in the prior search image.

S1703-7 (Bidirectional similarity determination step)

In this step, the SAD value stored in sad and the SAD value held in mind are compared with each other. The process proceeds to S1703-8 if sad is smaller than mind, or otherwise proceeds to S1703-9.

S1703-8 (Bidirectional most similar block information hold step)

In this step, i, j and sad are respectively stored in xd, yd and mind.

S1703-9 (Horizontal repeat count determination step)

In this step, the horizontal loop counter i is incremented by 1, and the process returns to S1701-3 if i is equal to or less than h, or otherwise proceeds to 1703-10.

S1703-10 (Vertical repeat count determination step)

In this step, the vertical loop counter j is incremented by 1, and the process returns to S1703-2 if j is equal to or less than v, or otherwise is terminated.

As described above, in this embodiment, in which the most similar block determined in S1702 is invariably used as the block in the prior search image in determination of the averaged block, the search range in the bidirectional reference can be the same as the search range in the non-prior search image. This search range is defined by four points (−h, −v), (−h, v), (h, −v) and (h, v). In other words, in this embodiment, the motion vector search of the non-prior search image and the bidirectional motion vector search can be performed simultaneously. In this case, SADs=mins, vecs=(xs, ys), SADd=mind, and vecd=(xd, yd).

As described above, in this embodiment, a prior search image and a non-prior search image are determined, and the non-prior search is performed simultaneously with the bidirectional motion vector search. This can reduce the computation amount compared with the case of performing the bidirectional motion vector search and a unidirectional search separately.

Also, with the simultaneous execution of the bidirectional motion vector search and a unidirectional search, it is only necessary to read reference block data commonly used for the two searches once, and thus the number of times of access to the memory can be reduced. The determination of the prior search image can be easily done using time-axis distance information.

### Embodiment 18

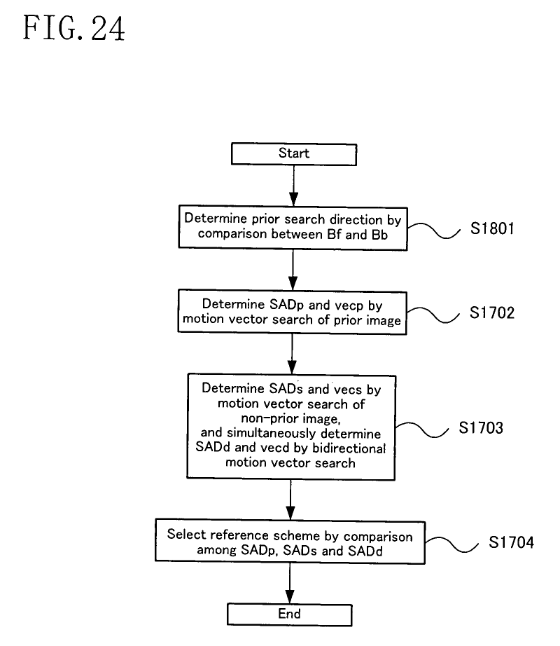

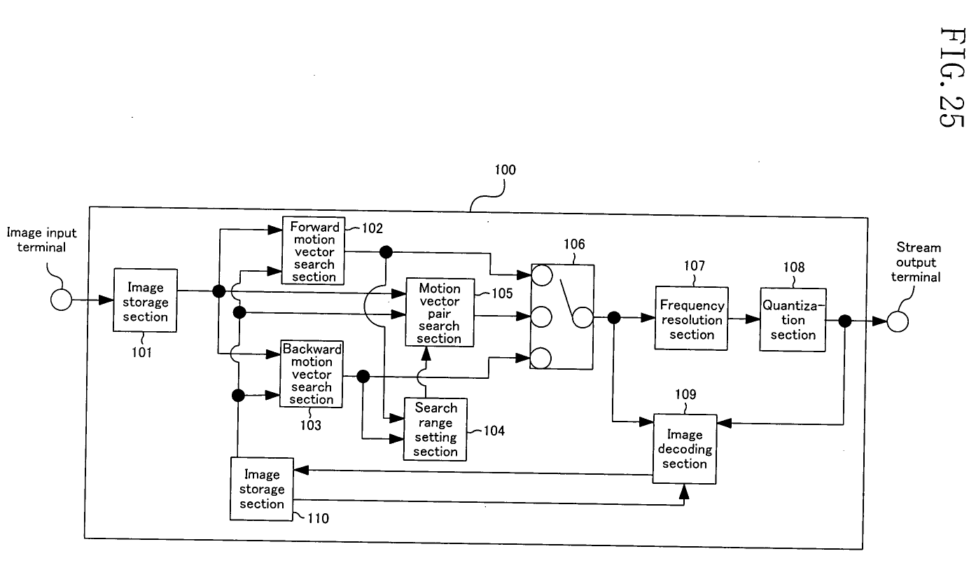

FIG. 24 is a flowchart illustrating a motion vector search method of Embodiment 18 of the present invention. The motion vector search method of this embodiment is different from that of Embodiment 17 (FIG. 22) in that S1801 replaces S1701.

In S1801 (prior search direction determination step), the number of blocks coded using the forward reference (forward reference scheme count Bf) and the number of blocks coded using the backward reference (backward reference scheme count Bb) are compared with each other, to determine a reference picture larger in the number of blocks as the prior search image.

Thus, in this embodiment, also, the determination of the prior search image can be easily done. This embodiment also permits reduction in computation amount compared with the case of performing the bidirectional motion vector search and a unidirectional search separately, and further has the effect of reducing the number of times of access to the memory.

### Embodiment 19

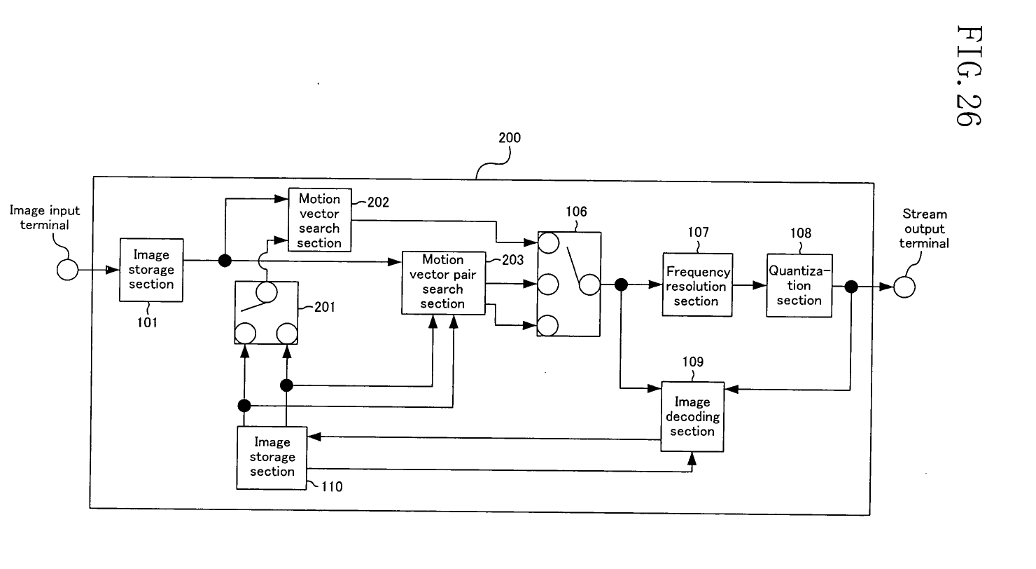

FIG. 25 is a block diagram of a motion vector search apparatus 100 of Embodiment 19 of the present invention, which is shown as an example of apparatus for implementing the motion vector search method of Embodiment 1.

As shown in FIG. 25, the motion vector search apparatus 100 includes an image storage section 101, a forward motion vector search section 102, a backward motion vector search section 103, a search range setting section 104, a motion vector pair search section 105, a reference scheme selection section 106, a frequency resolution section 107, a quantization section 108, an image decoding section 109 and an image storage section 110.

The image storage section 101 stores an inputted moving image signal, or specifically, stores the object image 10 to be coded.

The forward motion vector search section 102 searches a predetermined forward search range set in the forward reference image 20 (stored in the image storage section 110 as described later) for a block most similar to the object block 11 to be coded, to determine the similarity SADf between the object block 11 and the obtained most similar forward block 22 as well as the motion vector vecf therebetween.

The backward motion vector search section 103 searches a predetermined backward search range in the backward reference image 30 (stored in the image storage section 110 as described later) for a block most similar to the object block 11 to be coded, to determine the similarity SADb between the object block 11 and the obtained most similar backward block 32 as well as the motion vector vecb therebetween.

The search range setting section 104 sets the forward search range 21 and the backward search range 31. To state more specifically, the similarities obtained by the forward motion vector search section 102 and the backward motion vector search section 103 are compared with each other, and the search range of the reference image higher in similarity is set smaller than the search range of the other reference image.

The motion vector pair search section 105 retrieves one block from each of the forward search range 21 and the backward search range 31, to determine a motion vector pair (forward motion vector vec1 and backward motion vector vec2) and also determine an averaged block corresponding to the motion vector pair and the similarity SADd between the averaged block and the object block 11.

The reference scheme selection section 106 compares the similarities obtained by the forward motion vector search section 102, the backward motion vector search section 103 and the motion vector pair search section 105 with one another, to select a reference scheme to be used for coding, and outputs the motion vector and the difference block corresponding to the selected reference scheme.

The frequency resolution section 107 performs orthogonal transformation for the output of the reference scheme selection section 106.

The quantization section 108 quantizes the output of the frequency resolution section 107 and outputs the result to a stream output terminal and the image decoding section 109.

The image decoding section 109 decodes the output of the reference scheme selection section 106 and the output of the quantization section 108.

The image storage section 110 stores forward and backward reference images.

In the motion vector search apparatus 100 described above, first, coding with bidirectional reference is started in the state that both the forward and backward reference images are stored in the image storage section 110. Specifically, the forward motion vector search section 102 and the backward motion vector search section 103 respectively perform forward motion vector search and backward motion vector search, to determine the similarity and the motion vector for each reference scheme.

Once the similarities in the forward and backward schemes are determined, the search range setting section 104 sets the forward search range and the backward search range, while the motion vector pair search section 105 determines the motion vector pair and the similarity. The reference scheme selection section 106 compares the similarities determined by the forward motion vector search section 102, the backward motion vector search section 103 and the motion vector pair search section 105 with one another, to select a reference scheme to be used for coding. The reference scheme selection section 106 outputs the motion vector and the difference block corresponding to the selected reference scheme. The output of the reference scheme selection section 106 is coded by the frequency resolution section 107 and the quantization section 108, and then outputted.

### Embodiment 20

FIG. 26 is a block diagram of a motion vector search apparatus 200 of Embodiment 20 of the present invention, which is shown as an example of apparatus for implementing the motion vector search method of Embodiment 17. Note that components having substantially the same functions as those described in Embodiment 19 are denoted by the same reference numerals, and description thereof is omitted here.

As shown in FIG. 26, the motion vector search apparatus 200 includes the image storage section 101, the reference scheme selection section 106, the frequency resolution section 107, the quantization section 108, the image decoding section 109, the image storage section 110, a prior search direction determination section 201, a motion vector search section 202 and a motion vector pair search section 203.

The prior search direction determination section 201 selects one of the forward reference image and the backward reference image stored in the image storage section 110 that is shorter in the time-axis distance from the object picture, and outputs the selected one to the motion vector search section 202.

The motion vector search section 202 searches a search range set in the reference picture outputted from the prior search direction determination section 201 for a block most similar to the object block, and determines the similarity and the motion vector between the object block and the most similar block.

The motion vector pair search section 203 performs both the processing of searching a given search range in the reference picture that was not selected by the prior search direction determination section 201 (non-prior search image) for a block most similar to the object block and the bidirectional motion vector search processing simultaneously, to thereby obtain the motion vector and the similarity as the results of search of the non-prior search image and the motion vector and the similarity as the results of the bidirectional motion vector search. Note that in the bidirectional motion vector search processing, the most similar block determined by the motion vector search section 202 is used as one search object.

In the motion vector search apparatus 200 described above, first, coding with bidirectional reference is started in the state that both the forward and backward reference images are stored in the image storage section 110. Specifically, the prior search direction determination section 201 selects a reference picture shorter in the time-axis distance from the object picture and outputs the selected reference picture to the motion vector search section 202. The motion vector search section 202 determines the similarity and the motion vector using the image stored in the image storage section 101 and the image outputted from the prior search direction determination section 201.

The motion vector pair search section 203 searches a search range set in the non-prior search image for a block most similar to the object block, and simultaneously performs the bidirectional motion vector search processing, to thereby obtain the motion vector and the similarity as the results of search of the non-prior search image and the motion vector and the similarity as the results of the bidirectional motion vector search.

The reference scheme selection section 106 compares the similarities determined by the motion vector search section 202 and the motion vector pair search section 203 with one another, to select a reference scheme to be used for coding. The reference scheme selection section 106 outputs the motion vector and the difference block corresponding to the selected reference scheme to the frequency resolution section 107. The output of the reference scheme selection section 106 is coded by the frequency resolution section 107 and the quantization section 108, and then outputted.

Although the SAD value was used as the similarity in the embodiments described above, the similarity is not limited to this. For example, the sum of squared differences and the like may be used. In the computation of the SAD value, pixels used for SAD computation may be thinned, or the object block and the reference images may be scaled down, for reduction in computation amount.

Note that the above sizes (numbers of search points) of the forward and backward search ranges were presented by way of illustration.

Although the search range was defined by the four points (−h, −v), (−h, v), (h, −v) and (h, v) in S101 and S105, the way of setting the search range is not limited to this.

In the above embodiments, examples of B pictures with past and future pictures as the two reference images were described, as adopted in MPEG2 and the like. Alternatively, the present invention is also applicable to motion vector search of bi-predictive pictures, in which the two reference images are not limited to images past and future with respect to the object picture to be coded, as adopted in H.264 and the like, for example.

The motion vector search methods of the above embodiments may be implemented by software, or implemented by hardware as described in Embodiments 19 and 20, with which equivalent effects can be obtained.

As described above, the motion vector search method and the motion vector search apparatus according to the present invention have the effect of permitting improved coding efficiency for bidirectionally predictive coded images, and thus are useful as a motion vector search method used for compression of digital moving image data and a motion vector search apparatus for performing such motion vector search.

While the present invention has been described in preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

What is claimed is:

1. A motion vector search method for searching for a motion vector for each of object blocks to be coded constituting an object frame to be coded in execution of motion compensated interframe predictive coding of a moving image signal using two or more reference frames including a first reference frame and a second reference frame, the method comprising the steps of:
searching for a first motion vector based on a block retrieved from the first reference frame (first motion vector search step);
searching for a second motion vector based on a block retrieved from the second reference frame (second motion vector search step);
determining a combination of a block in the first reference frame and a block in the second reference frame so that the correlation of an averaged block of a block retrieved from the first reference frame and a block retrieved from the second reference frame with the object block is the highest, and searching for a motion vector pair based on the determined combination (third motion vector search step); and
selecting any among the first and second motion vectors and the motion vector pair (motion vector selection step).

2. The method of claim 1, wherein the third motion vector search step comprises a step of setting a region including a block corresponding to the first motion vector as a search range in the first reference frame and setting a region including a block corresponding to the second motion vector as a search range in the second reference frame (search range setting step).

3. The method of claim 2, wherein in the search range setting step, the search ranges in the first and second reference frames are set according to a first degree of correlation indicating the correlation between the block corresponding to the first motion vector and the object block and a second degree of correlation indicating the correlation between the block corresponding to the second motion vector and the object block.

4. The method of claim 3, wherein in the search range setting step, the search range in a reference frame corresponding to the higher one of the first and second degrees of correlation is made narrower than the search range in the other reference frame.

5. The method of claim 3, wherein in the search range setting step, one point indicated by a motion vector corresponding to the higher one of the first and second degrees of correlation is set as the search range in the reference frame corresponding to the higher degree of correlation.

6. The method of claim 4, wherein in the search range setting step, if the higher one of the first and second degrees of correlation is larger than a predetermined correlation threshold, one point indicated by a motion vector corresponding to the higher degree of correlation is set as the search range in the reference frame corresponding to the higher degree of correlation.

7. The method of claim 6, wherein the correlation threshold is set according to a time-axis distance between the first reference frame and the object frame and a time-axis distance between the second reference frame and the object frame.

8. The method of claim 6, wherein the correlation threshold is set according to the number of blocks coded using the first motion vector and the number of blocks coded using the second motion vector, among coded blocks surrounding the object block.

9. The method of claim 2, wherein in the search range setting step, the search ranges in the first and second reference frames are set according to a first time-axis distance indicating the time-axis distance between the first reference frame and the object frame and a second time-axis distance indicating the time-axis distance between the second reference frame and the object frame.

10. The method of claim 9, wherein in the search range setting step, the search range in a reference frame corresponding to the shorter one of the first and second time-axis distances is made narrower than the search range in the other reference frame.

11. The method of claim 9, wherein in the search range setting step, one point indicated by a motion vector corresponding to the shorter one of the first and second time-axis distances is set as the search range.

12. The method of claim 10, wherein in the search range setting step, if the shorter one of the first and second time-axis distances is smaller than a predetermined distance threshold, one point indicated by a motion vector corresponding to the shorter time-axis distance is set as the search range in the reference frame corresponding to the shorter time-axis distance.

13. The method of claim 2, wherein in the search range setting step, the search ranges in the first and second reference frames are set according to a first reference block count indicating the number of blocks coded using the first motion vector and a second reference block count indicating the number of blocks coded using the second motion vector, among coded blocks surrounding the object block.

14. The method of claim 13, wherein in the search range setting step, the search range in the first reference frame is set narrower than the search range in the second reference frame if the first reference block count is larger than the second reference block count, and the search range in the second reference frame is set narrower than the search range in the first reference frame if the second reference block count is larger than the first reference block count.

15. The method of claim 13, wherein in the search range setting step, one point indicated by the first motion vector is set as the search range in the first reference frame if the first reference block count is larger than the second reference block count, and one point indicated by the second motion vector is set as the search range in the second reference frame if the second reference block count is larger than the first reference block count.

16. The method of claim 14, wherein in the search range setting step, in the case that the search range in the first reference frame is set narrower than the search range in the second reference frame, if the first reference block count is larger than a predetermined reference block count threshold, one point indicated by the first motion vector is set as the search range in the first reference frame, and in the case that the search range in the second reference frame is set smaller than the search range in the first reference frame, if the second reference block count is larger than a predetermined reference block count threshold, one point indicated by the second motion vector is set as the search range in the second reference frame.

17. The method of claim 2, wherein in the search range setting step, the search ranges in the first and second reference frames are set according to
degrees of correlation between the reference frames and the object block,
time-axis distances between the reference frames and the object block, and
a first reference block count indicating the number of blocks coded using the first motion vector and a second reference block count indicating the number of blocks coded using the second motion vector, among coded blocks surrounding the object block.

18. A motion vector search method for searching for a motion vector for each of object blocks to be coded constituting an object frame to be coded in execution of motion compensated interframe predictive coding of a moving image signal using two or more reference frames including a first reference frame and a second reference frame, the method comprising the steps of:
searching for a first motion vector based on a block retrieved from the first reference frame (first motion vector search step);
searching for a second motion vector based on a block retrieved from the second reference frame (second motion vector search step);
determining a combination of a block in the first reference frame and a block in the second reference frame so that the correlation of an averaged block of a block retrieved from the first reference frame and a block retrieved from the second reference frame with the object block is the highest, and searching for a motion vector pair based on the determined combination (third motion vector search step);
deciding whether or not processing in the third motion vector search step is to be performed by evaluating the effectiveness of the third motion vector search step (decision step); and
selecting any among the first and second motion vectors and the motion vector pair if the processing in the third motion vector search step has been performed, or selecting one of the first and second motion vectors if the processing in the third motion vector search step has not been performed (motion vector selection step).

19. The method of claim 18, wherein in the decision step, the effectiveness is evaluated based on a pixel value of the object block.

20. The method of claim 18, wherein in the decision step, it is decided not to perform the processing in the third motion vector search step if the higher one of a first degree of correlation indicating the correlation between the block corresponding to the first motion vector and the object block and a second degree of correlation indicating the correlation between the block corresponding to the second motion vector and the object block is larger than a predetermined correlation threshold.

21. The method of claim 20, wherein the correlation threshold is set according to a time-axis distance between the first reference frame and the object frame and a time-axis distance between the second reference frame and the object frame.

22. The method of claim 21, wherein the correlation threshold is set according to the number of blocks coded using the first motion vector and the number of blocks coded using the second motion vector, among coded blocks surrounding the object block.

23. The method of claim 20, wherein the correlation threshold is set based on a pixel level of the object block.

24. The method of claim 18, wherein in the decision step, it is decided not to perform processing in the third motion vector search step if the shorter one of a first time-axis distance between the first reference frame and the object frame and a second time-axis distance between the second reference frame and the object frame is smaller than a predetermined distance threshold.

25. The method of claim 24, wherein the distance threshold is set based on a pixel level of the object block.

26. The method of claim 18, wherein in the decision step, it is decided not to perform processing in the third motion vector search step if the larger one of a first reference block count indicating the number of blocks coded using the first motion vector and a second reference block count indicating the number of blocks coded using the second motion vector is larger than a predetermined reference block count threshold.

27. The method of claim 26, wherein the reference scheme count threshold is set based on a pixel level of the object block.

28. A motion vector search method for searching for a motion vector for each of object blocks to be coded constituting an object frame to be coded in execution of motion compensated interframe predictive coding of a moving image signal using two or more reference frames including a first reference frame and a second reference frame, the method comprising the steps of:
selecting either one of the first reference frame and the second reference frame (search direction determination step);
searching for a first motion vector based on a block retrieved from the reference frame selected in the search direction determination step (first motion vector search step);
searching for a second motion vector based on a block retrieved from the other reference frame not selected in the search direction determination step, and simultaneously determining a block in the other reference frame so that the correlation of an averaged block of a block corresponding to the first motion vector and a block retrieved from the other reference frame with the object block is the highest and searching for a third motion vector based on the determined block to obtain a motion vector pair composed of the second and third motion vectors (motion vector pair search step); and
selecting any among the first and second motion vectors and the motion vector pair (motion vector selection step).

29. The method of claim 28, wherein in the search direction determination step, a time-axis distance between the first reference frame and the object frame and a time-axis distance between the second reference frame and the object frame are compared with each other, and a reference frame shorter in time-axis distance is selected.

30. The method of claim 28, wherein in the search direction determination step, the number of blocks coded using the first motion vector and the number of blocks coded using the second motion vector, among coded blocks surrounding the object block, are compared with each other, and a reference frame larger in the number of blocks is selected.

31. A motion vector search apparatus for searching for a motion vector for each of object blocks to be coded constituting an object frame to be coded in execution of motion compensated interframe predictive coding of a moving image signal using two or more reference frames including a first reference frame and a second reference frame, the apparatus comprising:
a first motion vector search section for searching for a first motion vector based on a block retrieved from the first reference frame;
a second motion vector search section for searching for a second motion vector based on a block retrieved from the second reference frame;
a third motion vector search section for determining a combination of a block in the first reference frame and a block in the second reference frame so that the correlation of an averaged block of a block retrieved from the first reference frame and a block retrieved from the second reference frame with the object block is the highest, and searching for a motion vector pair based on the determined combination; and
a motion vector selection section for selecting any among the first and second motion vectors and the motion vector pair.

32. A motion vector search apparatus for searching for a motion vector for each of object blocks to be coded constituting an object frame to be coded in execution of motion compensated interframe predictive coding of a moving image signal using two or more reference frames including a first reference frame and a second reference frame, the apparatus comprising:
a search direction determination section for selecting either one of the first reference frame and the second reference frame;
a first motion vector search section for searching for a first motion vector based on a block retrieved from the reference frame selected by the search direction determination section;
a motion vector pair search section for searching for a second motion vector based on a block retrieved from the other reference frame not selected by the search direction determination section, and simultaneously determining a block in the other reference frame so that the correlation of an averaged block of a block corresponding to the first motion vector and a block retrieved from the other reference frame with the object block is the highest and searching for a third motion vector based on the determined block to obtain a motion vector pair composed of the second and third motion vectors; and
a motion vector selection section for selecting any among the first and second motion vectors and the motion vector pair.
